(19) United States
(12) Patent Application Publication
(10) Pub. No.: US 2026/0341667 A1
(43) Pub. Date: Oct. 29, 2026

(54) COMPOSITE MATERIAL CONFIGURATION AND DISTRIBUTION FOR CONTROLLED DRY POWDER DEPOSITION AND DRY POWDER RETENTION

(71) Applicant: Sakuu Corporation, San Jose, CA (US)

(72) Inventors: Brian Flamm, Palo Alto, CA (US); Steven Zhichao SHI, Santa Clara, CA (US); Jin Zheng, San Jose, CA (US)

(73) Assignee: Sakuu Corporation, San Jose, CA (US)

(21) Appl. No.: 19/190,502

(22) Filed: Apr. 25, 2025

(51) Int. Cl. H01M 4/04; H01M 4/62

(52) U.S. Cl. CPC H01M 4/0404; H01M 4/043; H01M 4/622; H01M 4/625

(57) ABSTRACT

Systems, methods, and other embodiments associated with dry electrode material powder processing for manufacturing an electrode using composite materials with various formulations and properties that facilitate adhesion and powder spreadability at high line speeds. In one embodiment, a method includes forming a composite material layer on a top surface of a substrate, an upper surface of the composite material layer having at least one non-smooth micro-surface region formed thereon based on the composition of the composite material layer, depositing the dry electrode material powder on the upper surface of the composite material layer, and pressing the composite material layer, the top surface of the substrate, and the dry electrode material powder using at least one powder uniformization device to form a top electrode layer, the at least one non-smooth micro-surface region facilitates adhesion of the dry electrode material powder deposited thereon and promotes spreading of the dry electrode material powder.

### CROSS REFERENCE TO THE RELATED APPLICATIONS

This application is related to the pending U.S. patent application Ser. No. 18/391,024, filed on Dec. 20, 2023, and entitled “Electrode Fabrication Process”, the entire contents of which are incorporated herein by reference.

### TECHNICAL FIELD

The embodiments generally relate to substrate or platform coating methods in powder deposition systems and material or powder patterning systems that can include powder printing systems, 3D printing systems, and additive manufacturing machines and systems. In particular, the embodiments generally relate to apparatus, methods, and systems for configuring and distributing composite material(s) onto a substrate or platform to facilitate controlled dry powder deposition and dry powder retention on the substrate or platform.

### BACKGROUND

In typical powder printing, 3D printing, and additive manufacturing machines and systems, a material is dispensed onto a substrate and then processed (e.g., heated, sprayed, pressed, partitioned, removed, etc.,) to manufacture a product. For example, powder may be deposited on a conveyed substrate or build platform, applied with binder, and heated and pressed to build an electrode. Further, a coating can be applied to the substrate to aid in absorption or collection of deposited materials, for example, liquids, solvents, powders, solids, particles, additives, and composite materials commonly used to build a product on the substrate. The substrate can be prepared (i.e., coated) for product manufacturing. Generally, the coating undergoes no significant interaction between the substrate, the deposited material, and the manufacturing processes. The coating is not subjected to significant conditions such as significant heat and pressure prior to adhering to the deposited material. Thus, the coating properties remain significantly unchanged throughout product manufacturing.

Further, in manufacturing machines and systems where the substrate is coated on both sides, both coatings are generally identical and experience the same product manufacturing processes as applied on each side of the substrate. The interactions between the deposited material and the coating, and the coating and the manufacturing processes (e.g., conditioning/smoothing or compaction of the material) are minimal. In fact, the deposited material is commonly either a fluid or a cohered freestanding film on the substrate, and as such, coating interactions with the deposited material are not dependent on tribological properties of the deposited material. In other words, movement of the deposited material is not dependent or influenced by the configuration of the coating. Therefore, existing coatings and coating methods do not need to be configured to withstand product manufacturing processes such as excessive heat or pressure. However, when existing coatings (and existing coating methods) are subjected to significant pressure and/or heat, the properties of the coating can change detrimentally, becoming damaged or ineffective. As an example, when existing coatings are pressed/heated using heated rollers or calenders, undesirable interactions can be generated between the coating and the roller whereby the coating adheres/sticks to the roller. Moreover, when the coating is applied with pressure and heated the coating becomes flat and smooth and unable to adhere fluidized materials or materials configured to be flowable that are deposited on the coating at a high line speed. For example, conventional lithium-ion battery electrode manufacturing employs a wet coating process to form the battery electrodes from a slurry comprising the electrode active materials, binders and conductive additives, wherein a conductive coating or a primer layer is applied to a current collector (e.g., Al or Cu foil) to enhance adhesion and electrical conductivity between the electrode coating layer and the current collector. In emerging dry battery electrode manufacturing, however, such coating or primer layer on the current collector typically fails in providing adequate interactions between the coating and dry electrode powder materials, resulting in low spreading rate due to insufficient friction between the powder particles and the coating layer and poor powder deposition uniformity. Therefore, there is a need for a coating, coating system, and coating method that can provide a coating that can withstand significant pressure and/or heat while promoting improved spreading quality of the deposited material.

### SUMMARY (REWRITE BASED ON FINALIZED CLAIMS)

In an implementation, a method including forming a composite layer on a top surface of a substrate; depositing dry powder on the composite layer; creating a temperature gradient between the composite layer, the top surface of the substrate, and the dry powder; and pressing, during the temperature gradient, the composite layer, the top surface of the substrate, and the dry powder using at least one powder uniformization device to form a top electrode layer; the composite layer capable of being activated to facilitate adhesion of the dry powder to the top surface of the substrate.

In another implementation, a method including forming a composite material layer on a top surface of a substrate, an upper surface of the composite material layer, opposite to the top surface of the substrate, having at least one non-smooth micro-surface region formed thereon based on the composition of the composite material layer; depositing dry powder on the upper surface of the composite material layer; and pressing the composite material layer, the top surface of the substrate, and the dry powder using at least one powder uniformization device to form a top electrode layer; wherein the at least one non-smooth micro-surface region is not removed in forming the top electrode layer; and wherein the at least one non-smooth micro-surface region facilitates adhesion of dry powder deposited thereon and promotes spreading of dry powder.

### BRIEF DESCRIPTION OF THE DRAWINGS

The accompanying drawings, which are incorporated in and constitute a part of the specification, illustrate various systems, apparatus, methods, and one or more implementations of the disclosure. It will be appreciated that the illustrated element boundaries (e.g., boxes, groups of boxes, or other shapes) in the figures represent one implementation of the boundaries. In some implementations one element may be implemented as multiple elements or that multiple elements may be implemented as one element. In some implementations, an element shown as an internal component of another element may be implemented as an external component and vice versa. Furthermore, elements may not be drawn to scale. The drawing figures depict one or more implementations in accord with the present teachings, by way of example only, not by way of limitation. It is to be understood that the drawings are designed for the purpose of illustration only and not as a definition of the limits of the present disclosure. In the figures, like reference numerals refer to the same or similar elements. Furthermore, it should be understood that the drawings are not necessarily to scale. A complete understanding of the present implementations and the advantages and features thereof will be more readily understood by reference to the following detailed description when considered in conjunction with the accompanying drawings wherein:

FIG. 1 illustrates one embodiment of a schematic representation of a printing apparatus for depositing and processing composite materials on a substrate to facilitate desirable interactions between a composite layer formed on the substrate, a material (e.g., dry powder) deposited on the composite layer, and one or more powder uniformization devices configured to process the composite layer and deposited material, in accordance with aspects of the present disclosure;

FIGS. 2A-2D illustrate one embodiment of processing a substrate including dual-sided composite material and single-sided material (e.g., dry powder) deposition, the composite material layer formed on a substrate and configured to facilitate desirable interactions between a material (e.g., dry powder) deposited on the composite material layer, and powder uniformization devices configured to process the deposited material and substrate, in accordance with aspects of the present disclosure;

FIGS. 2E-2G illustrate one embodiment of processing a substrate including dual-sided composite material and dual-sided material (e.g., dry powder) deposition, the composite materials form a composite material layer configured to further facilitate desirable interactions between the material (e.g., dry powder) deposited on the composite material layer, and powder uniformization devices configured to process the deposited material and composite material layer, in accordance with aspects of the present disclosure;

FIG. 3 illustrates one embodiment of a flowchart depicting a process for depositing and processing a composite material layer deposited on a substrate, the composite material layer configured to facilitate desirable interactions between a material (e.g., dry powder) deposited thereon, and a powder uniformization device configured to process the deposited material and substrate, in accordance with aspects of the present disclosure;

FIGS. 4A-4B illustrate one embodiment of composite material components configured to facilitate desirable interactions between a composite material layer formed, a material (e.g., dry powder) deposited on the composite material layer, and powder uniformization devices configured to process the deposited material and composite material layer, in accordance with aspects of the present disclosure;

FIGS. 5A-5B illustrate one embodiment of composite material components configured to facilitate desirable interactions between a composite material layer formed, a material (e.g., dry powder) deposited on the composite material layer, and powder uniformization devices configured to process the deposited material and composite material layer, in accordance with aspects of the present disclosure;

FIG. 6 illustrates one embodiment of a flowchart depicting a process for depositing and processing composite materials configured to facilitate desirable interactions between a composite layer formed, a material (e.g., dry powder) deposited on the composite material layer, and powder uniformization devices configured to process the deposited material and composite material layer, in accordance with aspects of the present disclosure;

FIG. 7 illustrates one embodiment of a flowchart depicting a process for depositing and processing composite materials configured to facilitate desirable interactions between a composite layer formed, a material (e.g., dry powder) deposited on the composite material layer, and powder uniformization devices configured to process the deposited material and composite material layer, in accordance with aspects of the present disclosure; and

FIG. 8 illustrates one embodiment of an example composite material layer having a 3D porous deformable structure, the composite material layer configured to have deformable interlocking composite materials, in accordance with aspects of the present disclosure.

### DETAILED DESCRIPTION

Apparatus and methods are described herein as associated with composite material formulations and composite material layers configured to facilitate desirable interactions with a material (e.g., dry powder) deposited thereon and one or more powder uniformization devices and/or conditioning devices configured for conditioning, spreading and/or compaction of the composite material layer and/or deposited material (e.g., dry powder). Existing composite material layers fail to provide sufficient material (e.g., dry powder) adhesion to a substrate to prevent material (e.g., dry powder) peeling or defects at high temperature or pressure calendering stage. Moreover, existing composite material layers provide material (e.g., dry powder) surface uniformity at low line speeds and are typically calendered (smoothed out). However, at higher line speeds spreading defects and calendering defects are more pronounced making existing composite material layers unusable for practical battery manufacturing of dry powder.

The composite material layer of the present disclosure solves these problems and others, by configuring the composite material to facilitate desirable interactions with a material (e.g., dry powder) deposited thereon and one or more powder uniformization devices and/or conditioning devices configured for conditioning, spreading and/or compaction of the composite material layer and/or deposited material (e.g., dry powder). One desirable interaction of the composite material layer of the present disclosure is significant reduction/elimination of composite material layer to roller/calender stiction. As an example, the composite material layer may be configured to have varying thermal activation temperatures to facilitate significant reduction/elimination of composite material layer to roller/calender stiction. Another desirable interaction of the composite material layer of the present disclosure is improved adhesion of a material (e.g., dry powder) deposited thereon to facilitate higher line speeds and higher temperature and higher pressure calendering of the deposited material. As an example, the composite material layer may be configured to have non-smooth or locally non-uniform surface properties to facilitate improved adhesion of the deposited material to the surface of the composite material layer to prevent powder peeling at higher line speeds and calendering pressures. Another desirable interaction of the composite material layer of the present disclosure is improved spreading and surface uniformity of the deposited material (e.g., dry powder) on the composite material layer. As an example, the composite material layer may be configured to have non-smooth or locally non-uniform surface properties to facilitate improved material spreading, material loading, and material surface uniformity allowing wider coating widths and higher line speeds when the deposited material is processed by a conditioning device or powder uniformization device.

In a further aspect of the disclosure, the composite material layers of the present disclosure may be configured to have multiple properties, for example, differential thermal activation temperatures, non-uniform surfaces, non-smooth surfaces, and particles with additives or conductive layers to improve substrate to material thermal or electrical conductivity. On desirable interaction of such a composite material layer of the present disclosure is significant reduction/elimination of material (e.g., dry powder) spreading defects. As an example, the composite material layer may be configured to have varying thermal activation temperatures and non-smooth or non-uniform surface properties to facilitate significant reduction/elimination of spreading defects (rolling back/cratering defects, patches, streaks) by facilitating improved adhesion and spreading of the deposited material. Another desirable interaction of such a composite material layer of the present disclosure is significant reduction/elimination of calendering defects. As an example, the composite material layer may be configured to have varying thermal activation temperatures and non-smooth or non-uniform surface properties to facilitate significant reduction/elimination of calendering defects (wrinkles, scratches, peeling) through improved adhesion and spreading throughout conditioning and calendering process of the deposited material. Another desirable interaction of such a composite material layer of the present disclosure is increased powder loading (i.e., density) and binder loading due to better adhesion between the deposited material (e.g., dry powder) and the composite material layer. As an example, the composite material layer may be configured to have varying thermal activation temperatures and non-smooth or non-uniform surface properties to facilitate increased powder loading and binder loading due to improved material adhesion to the composite material layer at higher line speeds, higher temperatures, and higher pressure.

In many embodiments, the composite material layer of the present invention results in better deposited material (e.g., dry powder) density by enabling higher calendering pressures and temperatures without loss of material adhesion (or defects) at high line speeds.

### Printing Apparatus

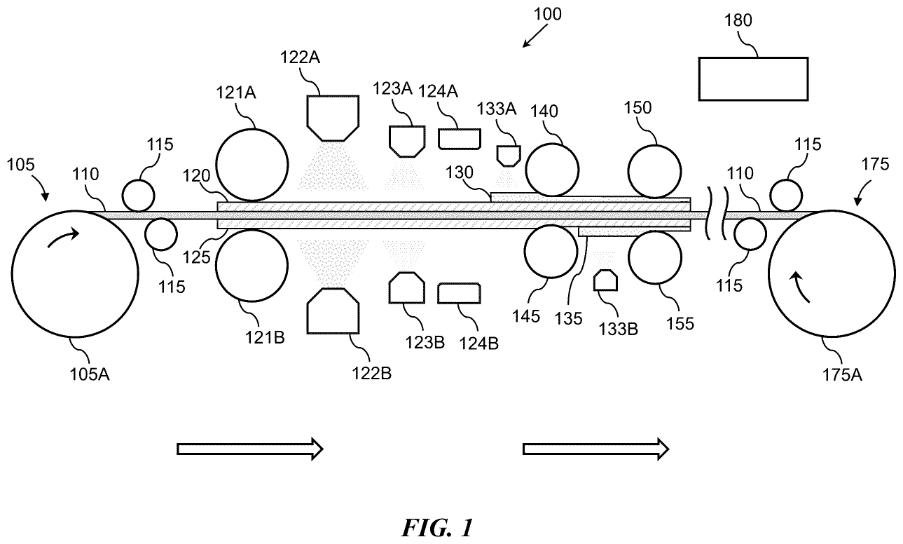

Referring to FIG. 1, an illustration of one implementation of a printing apparatus 100 configured for depositing and processing composite materials on a substrate, in accordance with one or more embodiments of the present disclosure. In certain implementations, the composite materials may be selected and configured to facilitate desirable interactions during processing of the composite material formed on the substrate, a material (e.g., dry powder) deposited thereafter on the composite material, and a powder uniformization device configured to process the composite material and the deposited material. In one embodiment, the printing apparatus 100 may include a conveying mechanism for transporting one or more substrates through various devices and components of the printing apparatus 100. In certain implementations, the printing apparatus 100 may be configured as a station-to-station printing apparatus whereby a transport device may be implemented to transport a substrate from one station to another station. For example, the transport device may transport the substrate from a station configured for deposition of the composite material, to another station configured for processing or conditioning of the composite material, to a further station for deposition of material (e.g., dry powder), and then a station for powder uniformization.

In some implementations, the composite materials can be configured to facilitate desirable interactions with the substrate when deposited as a composite layer or composite film on the substrate. In certain implementations, the composite materials may be configured to facilitate desirable interactions with other materials (e.g., dry powder) deposited over the composite materials. Further, in many implementations, the composite materials may be configured to facilitate desirable interactions when processed using conditioning devices that may be utilized to process these and other materials deposited on the substrate. In some embodiments, the substrate may be a continuous substrate or segmented substrate. In certain embodiments, the substrate may be a current collector web or foil used for forming and processing electrode layers as used in battery manufacturing. As an example, a composite material may be deposited on a current collector and processed to form a composite material film on the current collector. Thereafter, dry powder may be deposited on the composite film and processed together with the composite film to form an electrode layer. The electrode layer, composite film, and substrate may be processed together through one or more conditioning devices whereby the electrode layer has desirable characteristics such as surface uniformity, conductivity to the substrate, and adhesion to the substrate based on the selection and configuration of the composite material and formation of the composite film.

Referring again to FIG. 1, one implementation of a printing apparatus 100 with a continuous substrate 110 is illustrated, in accordance with one or more embodiments of the present disclosure. In one embodiment, the printing apparatus 100 may include a conveying unit 105, a conveying roll 105A, a reeling unit 175, and a reeling roll 175A. Further, the printing apparatus 100 may include one or more transfer rolls 115, composite material deposition devices 121A, 121B, composite material deposition devices 122A, 122B, binder deposition devices 123A, 123B, heating devices 124A, 124B (for heating or drying deposited composite material), powder deposition devices 133A, 133B, and controller 180. The printing apparatus 100 may be configured for depositing and processing composite materials deposited on the continuous substrate 110 as a composite layer 120 or composite film 125. The composite layer 120 can facilitate desirable interactions between the continuous substrate 110, a material 130 (e.g., dry powder) deposited on the composite layer 120, and a powder uniformization device(s) 140, 145, 150, and 155 configured to process the composite layer 120 and deposited material 130. Similarly, the composite film 125 can facilitate desirable interactions between the continuous substrate 110, a material 135 (e.g., dry powder) deposited on the composite film 125, and a powder uniformization device(s) 150 and 155 configured to process the composite film 125 and deposited material 135. In some implementations, the composite layer 120 and composite film 125 may be dried upon deposition. In some implementations, the composite layer 120 and composite film 125 may be compacted after drying. In some embodiments, the composite layer 120 and composite film 125 may be dried simultaneously or separately as desired.

In some implementations, the composite materials deposited by the printing apparatus 100 may facilitate adhesion of subsequently deposited material(s) to the continuous substrate 110. In certain implementations, the composite layer 120 and composite film 125 formed on the substrate 110 may be configured to prevent adhesion to an exterior surface of the powder uniformization device. In one implementation, the composite layer 120 (or composite film 125) may be configured to prevent stiction between the composite material and the powder uniformization device(s) 140, 145, 150, and 155. In many embodiments, the composite materials or composite material layers may be configured such that the properties of the composite material do not change when subjected to significant pressure or heat. Moreover, the composite material may be configured such that when the composite material is subjected to significant pressure or heat, the composite material does not generate undesirable interactions with the substrate 110, the deposited materials 130, 135, or powder uniformization device(s) 140, 145, 150, and 155.

### Conveying Mechanism

In a further aspect of the disclosure, in certain implementations, the printing apparatus 100 may include a conveying mechanism, for example, a conveying unit 105 for conveying substrate 110 for processing. As can be readily contemplated, one or more individual substrates 110 may be conveyed and processed by the printing apparatus 100. Similarly, one or more continuous substrates 110 may be conveyed and processed by the printing apparatus 100. In various implementations, the printing apparatus 100 and conveying unit 105 may be configured to transport substrate 110 to deposit thereon dry powder, composite materials, conductive materials, polymers, additives, plastics, agents, solvents, thermoplastic polymers, thermosetting polymers, ceramics, metal oxides, glass, metal powders, or any combinations thereof. Further, the conveying unit 105 may include a conveying roll 105A for driving and conveying one or more continuous substrates 110, as an example. In some embodiments, the continuous substrate 110 may be a current collector web and the conveying unit 105 may be a reeling roll device configured to unreel or unwind the current collector web for processing by the printing apparatus 100. Moreover, the printing apparatus 100 may include a reeling mechanism, for example, a reeling unit 175 for reeling or winding in the substrate 110 for transporting the substrate 110 through the printing apparatus 100. Further, the reeling unit 175 may include a reeling roll 175A for driving and collecting one or more continuous substrates 110 transported through, and processed by, the printing apparatus 100. Alternatively, in some embodiments, the printing apparatus 100 may be configured as a station-to-station printing apparatus to transport the substrate 110 to each station for preparing the substrate, depositing material(s) on the substrate, processing the substrate and material(s), conditioning, and building or stacking the substrate on another substrate, for example. The printing apparatus 100 when configured as a station-to-station printing apparatus may build, for example, a battery in its entirety including composite and material layers as disclosed herein, electrodes (anode and cathode), and packaging (e.g., the enclosure) of the battery, as an example. Moreover, the printing apparatus 100 when configured as a station-to-station printing apparatus may sequentially deposit and form a multi-layered structure on both sides of the substrate 110 using the composite materials as disclosed herein.

The printing apparatus 100 may include a plurality of transfer rolls 115 to facilitate transport and processing of substrate 110. The transfer rolls 115 may include at least one of guide rolls, process rolls, and torsion rolls. The transfer rolls 115 may facilitate guiding, processing, winding/unwinding, tension control, torque control, and web handling. As can be readily contemplated, one or more transfer rolls 115 may be provided on either side of the substrate 110 as needed. Moreover, a plurality of transfer rolls 115 may be utilized to facilitate a variety of conveying means to convey the current collector web along a predetermined path to be wound as a manufactured electrode, for example.

### Material and Composite Material Deposition

In a further aspect of the disclosure, in some implementations, the printing apparatus 100 may include one or more deposition devices 121A, 121B for transferring composite materials onto one or more surfaces of the substrate 110. In one embodiment, the deposition device 121A, 121B may include a gravure coating device configured to apply a controlled amount of composite material onto the substrate 110 to form a composite layer 120 or a composite film 125 of a predetermined thickness. As an example, the gravure coating device may facilitate high speed transfer and application of a precise amount of composite material onto a thin and flexible substrate 110 such as a current collector foil. In certain embodiments, one or more deposition devices 121A, 121B may include a micro-gravure coating device. In various implementations, the thickness of the composite layer 120 may be defined in a range from 1 μm to 200 μm, preferably 1 μm to 50 μm, and more preferably 1 μm to 10 μm. In various implementations, the thickness of the composite film 125 may be defined in a range from 1 μm to 200 μm, preferably 1 μm to 50 μm, and more preferably 1 μm to 10 μm. In some implementations, one or more deposition devices 121A, 121B may include a roll coating device to transfer composite materials onto substrate 110. In certain embodiments, one or more deposition devices 121A, 121B may include an electrostatic deposition device that uses an electric field to deposit composite materials onto a flexible conductive substrate 110.

In some implementations, the printing apparatus 100 may include one or more deposition devices 122A, 122B for transferring composite onto one or more surfaces of the substrate 110. In one embodiment, the deposition device 122A, 122B may include a slot-die coating device configured to apply to form a composite layer 120 or a composite film 125 of a predetermined thickness. As an example, the slot-die coating device may facilitate high coating speeds and precise control for coating thicknesses for a wide range of materials that may be used in the formulation of composite materials. The slot-die coating device may coat composite materials onto a flexible conductive substrate 110. In various implementations, the thickness of the composite layer 120 may be defined in a range from 1 μm to 200 μm, preferably 1 μm to 50 μm, and more preferably 1 μm to 10 μm. In various implementations, the thickness of the composite film 125 may be defined in a range from 1 μm to 200 μm, preferably 1 μm to 50 μm, and more preferably 1 μm to 10 μm. In some implementations, one or more deposition devices 122A, 122B may include a spray coating device to transfer composite materials onto substrate 110. In certain embodiments, one or more deposition devices 122A, 122B may include a doctor blade coating device configure to deposit and spread a controlled amount of composite material onto a continuous substrate 110. Moreover, other coating devices may be implemented as the deposition device 122A, 122B, include for example, and not limited to, an aerosol spraying coater, ultrasonic spray coater, blade coater, and curtain coater. The composite layer 220 and composite film 225 may be coated on the current collector using at least one of a wet deposition device (slot die coating device or gravure coating device), an aqueous coating device, or any other deposition or coating device as is known in the art.

In a further aspect of the disclosure, in some implementations, the printing apparatus 100 may include one or more binder deposition devices 123A, 123B configured for depositing binder on the substrate 110. In some implementations, binder deposition devices 123A, 123B may be excluded from the printing apparatus 100 and binder materials may be included or pre-mixed with the deposited material and/or composite layer 120 and composite film 125. In one embodiment, the binder deposition devices 123A, 123B may include, for example, inkjet printing devices, ultrasonic or pneumatic spray coating, spray coating, and various coating devices as described herein.

In some implementations, the composite material deposition may be decoupled from the powder deposition such that the printing apparatus 100 includes only the conveying mechanism and one or more of the deposition devices 121A, 121B, 122A and 122B. In a further aspect of the disclosure, deposition devices 121A, 121B, 122A and 122B may be configured as modular devices that can be detached from a printing apparatus. In one implementation, one or more deposition devices may be detached from one printing apparatus and attached to and configured for another printing apparatus. In some implementations, the printing apparatus may be configured to manufacture a composite material layer(s) on a substrate or roll. The substrate or roll may then be shipped to a customer or manufacturer for depositing materials thereon and further processing the composite material substrate/roll.

### Powder Deposition and Powder Considerations

In many embodiments, the printing apparatus 100 may include one or more powder deposition devices 133A, 133B having a funnel for receiving the powder and a moving surface and/or agitation device to fluidize and transport powder from within the funnel to a substrate. The powder deposition device 133A may be configured to deposit material 130 such as dry powder onto the composite layer 120, and the powder deposition device 133B may be configured to deposit material 135 such as dry powder onto the composite film 125. In one embodiment, the Additionally, the selection of powder materials and compositions are not restricted by the present disclosure, various materials, binders, and additives may be selected depending on the desired chemistry, application, and method of production. Some examples of powder compositions that may be utilized by the apparatus and method of the present disclosure are described in a related application by the Applicant (U.S. application Ser. No. 18/391,024), entitled “Electrode Fabrication Process,” filed on Dec. 20, 2023, and which is hereby incorporated by reference. The related application describes a method for manufacturing a battery electrode whereby dry particles are mixed with one or more electrode active materials, conductive additives, and one or more binder materials to form a binder-coated dry powder electrode material. The binder-coated dry powder electrode material can be used for a cathode or an anode. The dry powder electrode material is deposited onto an electrode current collector substrate using a dry powder dispensing device. In various examples described in the related application, the dry powder electrode material is a loose powder that can be poured at speed or mass rate from the dispensing device onto a moving current collector web in a roll-to-roll system. The dry powder electrode material may remain loose on the current collector web after deposition as it travels towards a compaction stage. After being poured onto the current collector, the loose dry powder electrode material is uniformly spread across the width of the moving current collector web by one or more spreading devices. The one or more spreading devices (e.g., conditioning devices) may include a doctor blade, one or more counter-rotating smoothing rollers, and one or more forward-rotating conditioning rollers.

Working with loose dry powders on a moving web prior to compaction is not trivial. Thus, in various examples, the constituent materials of the loose dry powder electrode material are chosen to achieve a balance between flowability and cohesion. The flowability of the loose dry powder electrode material is tuned to allow these materials to readily pour from the dispensing device, yet not too flowable that it scatters upon hitting the moving web or is easily disturbed by the movement and associated vibration of the web. Additionally, an electrode layer must be smooth and uniform in thickness after compaction and a material that is too flowable does not compact well when calendered. Attempts to compact a highly flowable material with a calender often include streaks in the direction of the moving web as the flowable powder is pushed down the current collector web by the calender or the powder slips. Conversely, if the loose dry powder electrode material is too cohesive, it comes out of the powder dispenser in clumps, does not spread well, and does not create a smooth and uniform layer when calendered or spread (e.g., there is often separation between individual clumps). Thus, the constituent materials of the loose dry powder electrode material are chosen to achieve a balance between flowability and cohesion. The powder layer, whether used for an electrode of an anode or cathode, must be smooth and uniform in thickness to improve a compaction rate at a calendering stage. Moreover, the powder materials and composition, the composite material layer, the composite material film, and the powder dispensing unit must be selected and configured for a roll-to-roll system, for example, to obtain uniform powder deposition across a width of the roll.

In a further aspect of the disclosure, improvement in powder mass flow, powder adhesion to the substrate (and composite layer and film), and uniform powder deposition from the powder deposition devices 133A, 133B can be achieved by engineering powder materials and compositions. In various implementations, a morphology of a powder material can be tuned to improve adhesion, flowability and cohesion of the powder material on the substrate (and composite layer and film) described herein. As described herein, in various implementations, the apparatus and method of forming and processing composite layers and composite films on the substrate facilitates improved compaction of the deposited powder layer prior to smoothing and conditioning rollers and a calendering stage in the roll-to-roll system.

In one implementation, the powder compositions may be used to form electrode layers using active material particles to form an anode or cathode, using one or more conductive additives, and one or more binder materials may be mixed to form a dry powder electrode material. In one embodiment, the one or more binder materials include 0.5-2 wt % PVDF which is mixed with active material particles and conductive additives. In other embodiments, 2-4 wt % PVDF is used. The active material particles and one or more binder materials, in one embodiment, are dry mixed to achieve a partial coating of PVDF over the active material particles that is between 50 and 85%. Additionally, the dry particles are mixed for a duration and at shear forces sufficient to attach 70-100% percentage of fine binder particles onto the surface of the active material particles to achieve a D50 of 7-12 μm to achieve a Hausner ratio between 1.3-1.45.

In various implementations, loose dry powder may be placed in a hopper or funnel of the powder deposition devices 133A, 133B. The dry powder may be produced by dry mixing particles of one or more active electrode materials, conductive additives, and one or more binder materials, constituent materials of the loose dry powder electrode material are chosen to achieve a balance between flowability and cohesion. Examples of dry powder materials used to form a cathode or anode may include, for example and not limited to, carbon black, activated carbon, graphite, graphene, carbon fiber, and carbon nanotubes, copper, aluminum, nickel, silver, pearl graphite, carbon-polymer composite, metal-polymer composite, or combinations thereof. Examples of anode active material include lithium, lithium powder, molten lithium, semi-liquid lithium, lithium titanium oxide, silicon, silicon oxide, hard carbon, and graphite or combinations thereof. Examples of cathode active material include lithium iron phosphate (LFP), lithium manganese iron phosphate (LMFP), lithium cobalt oxide (LCO), lithium manganese oxide (LMO), lithium nickel cobalt aluminum oxide (NCA), lithium nickel cobalt manganese aluminum oxide (NCMA), lithium nickel manganese cobalt oxide (NMC) and all its variants, lithium nickel manganese oxide (LMNO), lithium vanadium oxide (LVO), lithium iron disulfide, silver vanadium oxide, carbon monofluoride, copper oxide, sulfur, or combinations thereof. As an example, pearl graphite may be selected as a dry powder material for an anode formed by mixing an anode active material (e.g., graphite) with a conductive additive (e.g., conductive carbon) in a first mixing process. The pearl graphite may have sufficient flowability with a particle size of D50 in, for example, a range of 5-20 μm at ~93 wt %. The conductive carbon, in this example, is 1.5 wt % with a particle size of D50 in the range of 1 nm to <1 μm.

Any suitable mixing process may be used, and multiple mixing processes may be implemented. As an example, a dry powder anode material may be formed by mixing an anode active material (e.g., graphite) with a conductive additive (e.g., conductive carbon) in a first mixing process. In some embodiments, a second mixing process may be performed to mix the graphite/conductive carbon mixture with a binder, for example but not limited to, Polyvinylidene Fluoride (PVDF). In one embodiment, 0.5-5 wt % binder may be used in the mixing process. Alternatively, higher concentrations of 12 wt % binder may also be used. The resulting composite powder has improved dry powder flowability compared with other pure powder, such as NM C by itself.

In one embodiment, a small amount of solvent can be added during the mixing process as a process aid. The solvent may be removed during later stages of the mixing process or immediately after. The result is increased binding efficiency as a result of modifying the shape and structure of the binder. The solvent can be removed through mild heating (80 °C-160 °C), thus “locking in” a modified structure of the binder to create a dry active material powder. This dry active material powder can then be deposited onto a current collector, as an example.

[Full binder coat] In a further aspect of the disclosure, various example implementations of binder material(s) may be utilized in powder engineering a powder material for a desired flowability, cohesion, handleability, and other benefits as described herein. In one implementation, the morphology of a powder material includes coating an active material particle with a binder layer to improve flowability of the material particle. In one embodiment, the dry powder electrode material particle may include an active material particle coated with a binder layer (e.g., Polyvinylidene Fluoride (PVDF)). The binder layer may be produced by dry mixing active material, 0.50-20 wt % binder, and conductive additives. The binder layer may be used to coat, in part or in whole, the surface of active material particle to promote flowability. For example, a relatively higher concentration of binder in loose dry powder electrode material has been shown to result in a balance of flowability and cohesion when mixed using relatively higher shear forces.

[Partial binder coat] In certain embodiments, an example morphology of a dry powder electrode material particle may include a spherical active material particle, such as cathode active material NM C, with partial binder coating. In one embodiment, the partial binder coating may be produced by dry mixing active material, 2 wt % PV DF, and conductive additives at relatively lower shear forces. As an example, a partial binder coating may cover 60-70% of the surface of an active material particle. In some embodiments, partial binder coating may limit the PVDF to being a surface adherent to the active material particles after compaction and binder activation resulting in sufficient space (e.g., voids, cavities, etc.,) between active material particles in the electrode layer for electrolyte penetration whereby flowability is improved but electrochemical properties are limited. In some embodiments, an example morphology of a dry powder electrode material particle may include an amorphous active material particle, such as cathode active material LFP, with partial binder coating.

[Porous binder coat] In some embodiments, an example morphology of a dry powder electrode material particle may include spherical active material particle, such as cathode active material NMC, with porous binder coating. Additionally, the resulting morphology, its porous nature, and spread of the binder layer result, in one embodiment, in an increase in ionic conductivity due to capillary forces that encourage electrolyte penetration toward and access to active material particle. In one embodiment, the porous binder coating may be a matrix of nano PVDF particles (200-500 nm in diameter). The matrix, in one embodiment, may appear as a porous hard-spongelike layer composed of many nano PV DF particles attached to each other surrounding active material particle and can range from areas of no coverage on the surface of active material particle to areas of multiple nano PV DF particles thick. In one embodiment, porous binder coating, may be produced by dry mixing the active material, 2 wt % nano PV DF, and conductive additives at low shear forces. As an example, powder material particles may have a 70-90% binder surface coverage of active material particle. In certain embodiments, an example morphology of a dry powder electrode material particle may include amorphous active material particle, such as cathode active material LFP, with porous binder coating.

In some embodiments, higher shear forces exerted in the mixing of particles can cause the binder (e.g., full binder coating or partial binder coating of the active material particle) to at least partially deform and mold to the surface of the active material particles. Conversely, the relatively lower shear forces may be exerted when mixing dry powder electrode material particle cause the nano PVDF particles (e.g., porous binder coating) to adhere to the surface of active material particle and to each other (to form a three-dimensional matrix of particles) without complete deformation. Accordingly, porous binder coating causes increased friction having a Hausner ratio of roughly 1.38-1.45 and, thus, dry powder electrode material particle with porous binder coating of the active material particle does not flow as well as dry powder electrode material particles with full binder coating or partial binder coating of the active material particle yet can have superior electrochemical properties.

[Hybrid binder coat] In various implementations, any suitable thermoplastic binder compositions other than PVDF binder may be used to produce the dry powder material. In some embodiments, a hybrid binder composition may be used to obtain a desired balance between flowability and cohesion of the dry powder to produce a uniform powder layer. In various implementations, the hybrid binder composition may comprise a thermoplastic binder and a thermally curable binder, a UV curable binder, or two or more UV curable compositions where each binder is cured by UV radiation at a wavelength different from each other. When a hybrid binder comprising one or more of thermoplastic binder, thermally curable binder and UV curable binder is used, one or more of the components of the hybrid binder can be selectively cured or partially cured at a curing station to improve the cohesion and handleability of the dry powder material layer to prevent breaking down of the first layer during flipping through turn rollers.

In one embodiment, the hybrid binder composition may comprise one or more B-stage binder compositions which are partially cured, i.e., in the B-stage state. In various implementations, one or more of the components of the hybrid binder composition can be selectively cured or partially cured to tune the flowability and cohesion of the dry powder during the dry powder mixing process as described above or during a dry powder electrode manufacturing process. In various implementations, a dry powder material manufacturing process may include any suitable lubricating agents including organic materials (e.g., organic solvents) and other materials added to water that may be used to improve the cohesion and uniform compaction of the dry powder material. The amount of lubrication agent applied to the dry powder electrode material can be less than 10 wt %, preferably less than 5 wt %. In another example, the lubricating agent can serve as an activation agent to activate binder curing.

[Other binders] In some embodiments, the binder coated powder may comprise one or more of organic binders or inorganic binders or combinations thereof. The organic binder can comprise either a thermally curable composition, UV curable composition, or a photocurable composition or combinations thereof. In some implementations, the binder may comprise a ceramic precursor, such as polycarbosilane or polysiloxane which can thermally react and become part of the printed object during the post-printing process, e.g., sintering. In various embodiments, the binder coated powder can be made by any of the various particle coating techniques including but not limited to dry mixing, solvent evaporation, spray coating including spray drying and spray congealing, air suspension coating (also termed as fluidized bed coating), pan coating, centrifugal extrusion and multi-orifice centrifugal process, and the like. In various implementations, spray drying may be applied to the particles of the powder to impart fluidity on the powder in addition to, or in lieu of, other powder engineering processes described herein.

[Binder selection and limitations] In various aspects of the disclosure, powder engineering may include selection and configuration of one or more binder materials to hold the particles in place to make a cohesive layer. In many embodiments, application of binder material(s) and binder material amounts may be limited to the contact points between particles thereby limiting the binder contact points to promote sufficient electrolyte penetration into the resulting compacted powder layer (e.g., in a post-calendered electrode layer). There are multiple factors that may encourage the morphology of a dry powder electrode. One factor is the appropriate amount of binder, excessive use of binder would fill an unnecessary volume between particles, yet inadequate use of binder would not ensure sufficient particle to particle adhesion. Another factor is binder particle size; selection of small particles may not congeal as readily as larger agglomerates when melted, causing the binder to remain a surface adherent (i.e., keeping the binder from filling in the cavities between particles). Another factor is mixing intensity or shear force; the shear forces need to be strong enough to enable the binder particles to adhere to the active material particle surface, but not too strong that they deform and melt together and fully coat the particle surface limiting electrolyte penetration. Another factor is calendering pressure and heat; too much pressure and the structure collapses. Accordingly, the resulting morphology of dry powder electrode is a porous structure that, in one embodiment, increases ionic conductivity due to capillary forces that encourage electrolyte penetration toward and access to the active material particle.

### Conditioning Devices

In a further aspect of the disclosure, in some implementations, the printing apparatus 100 may include one or more conditioning devices configured for individually processing the substrate 110, the composite layer 120, the composite layer 120 with material deposited thereon, the composite film 125, and the composite film 125 with material deposited thereon. In one embodiment, the printing apparatus 100 may include a pair of similar conditioning devices for preparing the composite layer 120 and composite film 125 for material deposition. In some embodiments, the printing apparatus 100 may include a pair of similar conditioning devices for processing material deposited on the composite layer 120 and material deposited on the composite film 125. In one embodiment, the heating devices 124A, 124B may be configured for drying, warming, or preparing the composite layer 120 and the composite film 125 for material deposition thereon. In some embodiments, the printing apparatus 100 may include additional heating devices configured for warming and preparing the material (e.g., dry powder) deposited on composite layer 120 and composite film 125 for powder uniformization and powder compaction, as an example. Moreover, as can be readily contemplated, the substrate 110, composite layer 120 and composite film 125 deposited and formed thereon, and material 130, 135 layers deposited and formed thereon may be processed using conditioning devices positioned adjacent to the surface of the substrate 110, positioned on either side of the substrate 110, positioned directly over or touching the substrate 110, or any combinations thereof.

In certain implementations, warming of the composite layer 120 and composite film 125 using heating devices 124A, 124B may facilitate adhesion of the composite layer 120 to a surface of the substrate 110 and/or adhesion of the composite film 125 to another surface of the substrate 110. In one embodiment, the one or more heating devices 124A, 124B may be facilitated by an oven unit that encloses and heats the substrate 110, the composite layer 120, and composite film 125. In one implementation, the oven unit may be positioned adjacent to one or more powder uniformization devices to warm up material deposited on the composite layer 120 or composite film 125. The material deposited on the composite layer 120 and composite film 125 may be warmed up prior to (and after) powder spreading and compaction. In certain embodiments, each of the one or more heating devices 124A, 124B may include an IR, microwave, or UV heating devices, as an example.

In one implementation, the printing apparatus 100 may include one or more powder (or material) spreading, heating, and compaction devices configured for conditioning material deposited on the substrate 110, on the composite layer 120, and on the composite film 125. As an example, the printing apparatus 100 may include powder uniformization devices 140, 145, 150, and 155. The powder uniformization device as disclosed herein may be configured to be at least one of a stationary spreading roller (e.g., squeegee or doctor blade), a heated roller to apply heat to the deposited material (e.g., dry powder), the composite material, or the substrate, a rotating roller that rotates and applies pressure in a tangential direction that is the same as the direction of movement of the substrate, and a counter-rotating roller to apply pressure that rotates and applies pressure in a tangential direction opposite to the movement of the substrate. With reference to FIG. 1, in some implementations, each set of powder uniformization devices 140, 145, 150, and 155 may be aligned and configured to be equidistant from the substrate 110. In certain implementations, the powder uniformization devices 140, 145, 150, and 155 may be horizontally offset and configured to have different distances from the substrate 110.

In certain implementations, powder uniformization devices may be distributed on one or more sides of the substrate 110. In one embodiment, one or more powder uniformization devices may be distributed on each side of substrate 110. Further, one or more powder uniformization device may be configured to apply low, moderate, or high pressure to either side of substrate 110, composite material layer, or deposited material (e.g., dry powder). Moreover, the one or more powder uniformization devices may be placed throughout the printing apparatus 100 to apply a low, moderate, or high temperature heating to a composite material layer, a substrate, and materials thereon, or any combination thereof. In various implementations, the application of low pressure may be defined in a range from 50 MPa to 100 MPa (Mega Pascals) (~500 to ~1,000 kg/cm²), application of moderate pressure may be defined in a range from 100 MPa to 700 MPa (~1,000 to ~7,100 kg/cm²), and application of high pressure may be defined in a as above 700 MPa (~1,000 kg/cm2), and preferably in a range from 700 MPa to 5,000 MPa (7,100 to 51,000 kg/cm²) and above (based on primer material selection). In some embodiments, a heating device may be utilized and configured to apply low, moderate, or high temperature heating to either side of substrate 110, composite material layer, or deposited material (e.g., dry powder) during, prior to, or after spreading and/or compaction of the deposited material. In various implementations, the application of low temperature heating may be defined in a range from 25 °C to 90 °C, application of moderate temperature heating may be defined in a range from 90 °C to 150 °C, and application of high temperature heating may be defined as above 150 °C, and preferably in a range from 150 °C to 225 °C. In many implementations, a powder uniformization device may include a heating device to spread and apply pressure to the material (e.g., dry powder) deposited and apply low, moderate, or high temperature heating to either side of substrate 110 during spreading and/or compaction.

In some implementations, the printing apparatus 100 may include one or more powder uniformization devices configured as stationary rollers to facilitate surface uniformity or smoothing of the deposited material (e.g., dry powder). In certain implementations, the printing apparatus 100 may include one or more powder uniformization devices configured as rotating or counter-rotating rollers to facilitate spreading and compaction of the deposited material (e.g., dry powder). In some implementations, the printing apparatus 100 may include more than four powder uniformization devices as needed to process and condition material deposited on the composite layer 120 and material deposited on the composite film 125. In certain implementations, the printing apparatus 100 may include fewer than four powder uniformization devices as needed to process and condition material deposited on the composite layer 120 and material deposited on the composite film 125.

In one implementation, the printing apparatus 100 may be configured to create one or more temperature gradients between the substrate 110 and the powder uniformization device 140, 145, 150, and 155. Further, in some implementations, the printing apparatus 100 may be configured to create one or more temperature gradients between the substrate 110 and any composite layer 120 and composite film 125 deposited and formed thereon. Moreover, in certain implementations, the printing apparatus 100 may be configured to create one or more temperature gradients between the substrate 110, the material 130, 135 layers deposited and formed thereon, and any conditioning devices positioned adjacent to (or opposite of) the substrate 110. In various implementations, a low temperature gradient may be defined in a range from 10 °C to 40 °C, a moderate temperature gradient may be defined in a range from 40 °C to 75 °C, and a high temperature gradient may be defined in as 75 °C and above, and preferably in a range from 75 °C to 115 °C. In one embodiment, the temperature gradient may be defined as the temperature difference between the top surface of the substrate 110 and the top surface of the composite layer 120. In some embodiments, the temperature gradient may be defined as the temperature difference between the top surface of the substrate 110 and the top surface of the material 130 deposited and formed on the composite layer 120. Similarly, in one embodiment, the temperature gradient may be defined as the temperature difference between the bottom surface of the substrate 110 and the top surface of the composite film 125. In some embodiments, the temperature gradient may be defined as the temperature difference between the bottom surface of the substrate 110 and the top surface of the material 135 deposited and formed on the composite film 125.

### Controller

In a further aspect of the disclosure, the printing apparatus 100 may include a controller 180 programmed to configure various devices and components of the printing apparatus 100 as described herein, to facilitate synchronized deposition, conditioning, and processing of composite materials and deposited materials (e.g., dry powder). Moreover, the controller 180 may be programmed to configure conditioning devices to facilitate cohesion and adhesion of deposited materials (e.g., dry powder) on the substrate and on the composite layer or film. In many implementations, the controller 180 may be programmed to independently adjust and synchronize the movement of the substrate 110, transfer rolls 115, conveying unit 105, reeling unit 175, powder uniformization devices 140, 145, 150, 155, material deposition devices 122A, 122B, binder deposition devices 123A, 123B, powder deposition devices 133A, 133B, and other conditioning devices as described herein. These adjustments and synchronizations may include matching the rate of motion in some or all directions such as matching the X motion of the substrate to the tangential motion of the powder uniformization device, for example. This matching of motion may be accomplished through programming of the controller based on feedback from one or more sensors (not shown) that provide visual data from processing and conditioning, and/or measure distances and physical contact of portions of the material deposited on the composite layer or film.

### Composite Material Formation and Formulation

In a further aspect of the disclosure, the formulation (e.g., additives, dispersions, agents, etc.,), physical properties, (e.g., layer thickness, particles sizes and distributions, tribological properties, etc.,) and electrochemical properties (e.g., conductivity) of the composite material layer as described herein may be selectively chosen and adjusted based on the substrate material, environmental conditions, and material deposited thereon. In many implementations, the composite material may be configured to include one or more composite material components such as, for example, roughening agents, tacking materials, carbon coated microspheres, wetting agents, binders, anti-blocking agents, co-binders, solvents, conductive materials, polymers, adhesion promoting materials and coatings, and additives (conductive and non-conductive), or any combinations thereof. In some embodiments, co-solvents may be implemented as a composite material component to alter composite material formulation rheology properties, thus facilitating the composite material coating process and improving the composite material coating properties (e.g., wettability) and the coating layer quality (e.g., uniformity). In some embodiments, removal of solvent material facilitates a 3D porous structure for the composite material layer as further described below. In some implementations, other pore forming agents may be selectively added to control the porous structure of the composite material layer. Each of these composite material components, when implemented, may contribute to a percentage volume of the composite material, or a volume fraction of the total volume of the composite material. Further, the composite material layer thickness may be adjusted as needed to reduce/eliminate stiction or adhesion of the composite material to conditioning/processing devices. Moreover, the particle sizes and distributions of the composite material formulation may be adjusted as needed to provide adequate surface roughness to facilitate adhesion to a substrate and spreading and surface uniformity (cohesion and adhesion) of materials (e.g., dry powder) deposited thereon. Further, in many implementations, the composite material components may be selected and configured such that the composite material layer is resilient to significant pressure and/or heat (i.e., deformation or defects) at a calendering stage or other conditioning process. Moreover, in many implementations, the composite material components may be selected to facilitate electrical and heat conductivity between the material deposited thereon and a substrate for receiving/supporting the composite material layer. Further, different composite material formulations can be formed/coated onto each side of the substrate (e.g., current collector), or deposited at separate stations of a printing apparatus, or at separate passes on a roll-to-roll coating machine, or any combinations thereof. Moreover, as described herein, the composite material layer may be configured to exhibit different properties to optimize layer interactions during a multi-step deposition process. The composite material components may be added to the composite material layer (e.g., composite layer or composite film) at any point during processing of the substrate and/or composite material layer by the printing apparatus. For example, composite material components may be added to the composite material layer prior to or after conditioning of the substrate and materials deposited thereon.

In a further aspect of the disclosure, in some implementations, the composite material may be configured to be solvent free. As an example, the composite material may be configured to include a UV curable binder material. The UV curable binder material may be included in the composite material as a liquid monomer that functions as a liquid vehicle to disperse the conductive carbons and additives. By using UV curable binder, the use of solvent and water can be eliminated from the composite material thereby saving costs and being more environmentally friendly. In some implementations, the UV curable binder may be added to the composite material prior to depositing and processing a composite material layer. In certain implementations, the UV curable binder may be added to the composite material layer and then further processed.

In a further aspect of the disclosure, the composite material may be configured to include composite material components to facilitate formation of a composite material layer having a 3D porous deformable structure. The 3D porous composite material layer may be configured to be deformable enough during composite material layer processing, for example, heating, smooth via a smoothing roller, conditioning via a conditioning roller, and so forth. The 3D porous composite material layer may be densified during compaction together with the deposited material (e.g., dry powder) thereby making the thickness of the composite material layer negligible. In certain embodiments, the 3D porous composite material layer may be heated to increase porosity. In some implementations, the composite material layer may undergo one or more stages of deformation processing including, for example, densification (e.g., compaction) and porosity processing (heating, use of pore forming agents, etc.,). The 3D porous composite material layer may be configured to be deformable during compaction and further densified during compaction without sacrificing adhesion properties for adhering, for example, dry loose powder at high line speeds (e.g., high powder spreading speeds) to a current collector surface. As further described herein, multiple components and composite material layer formulations may be used on one or more surfaces of the substrate as desired.

Composite Materials with Solids/Solid Dispersions

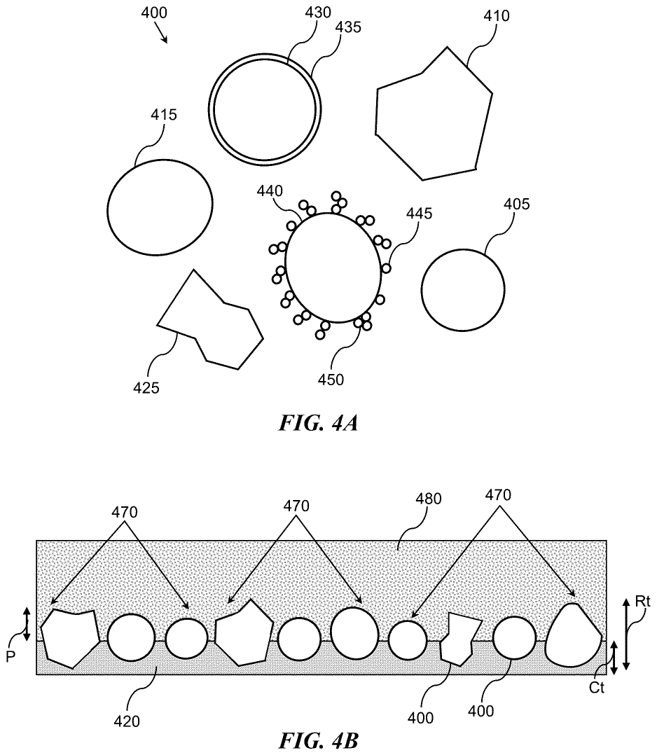

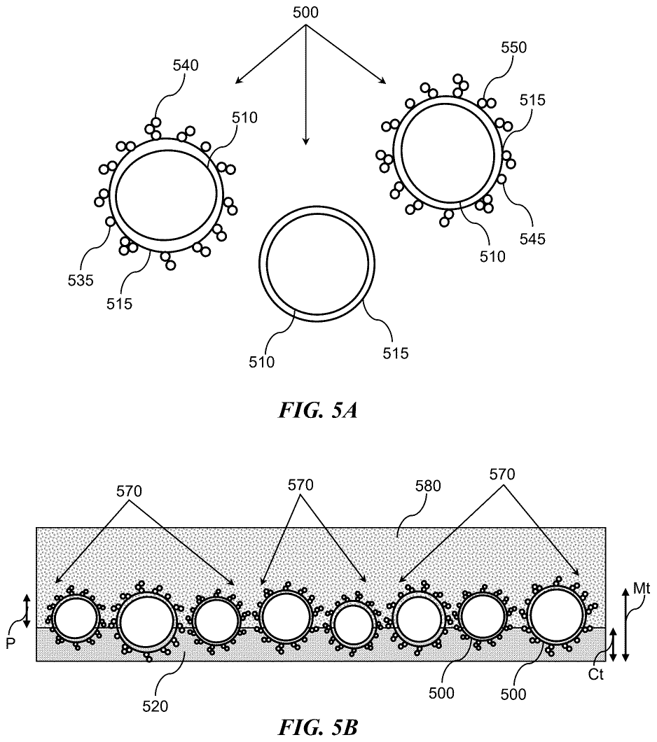

In a further aspect of the disclosure, the composite material may be configured to include a predetermined amount of solids (i.e., solid particles) loading to facilitate formation of a composite material layer having a roughened surface as shown in FIGS. 4A-4B and 5A-5B. The solid particles may form non-smooth or non-uniform surface regions on a top surface of the composite material layer. In some embodiments, the non-uniform/non-smooth surface regions of the composite material layer can facilitate adhesion of deposited material (e.g., dry powder) or fluidized material (e.g., loose dry powder). The solid particles may be added directly to the composite material or added via a dispersant as is known in the art. In one embodiment, the solid weight percentage (% wt) added into the composite material may comprise of 5 wt % solids. It can be readily contemplated, that solids % wt defined herein may be defined as a nominal weight percentage which can contribute (e.g., bond or fuse) to other additives/solvent solid materials resulting in an actual/total weight percentage of solids being 10-15% above the nominal solid % wt. Moreover, solid % wt may be adjusted as needed based on composite material layer heating/dry requirements, composite materials (e.g., additives, binders, solvent), composite material layer thickness, and deposited materials (e.g., dry powder). In many embodiments, adding/increasing solids can help to facilitate lower solvent drying requirements, more efficient coating utilization (m/kg), lower concentrations of fluid additives (rheological modifiers, wetting agents, etc.,), lower cost, as well as improved dispersion and stability through higher viscosity to adhere to the substrate surface and higher surface friction for retaining/adhering deposited or coated materials. Some examples of solids include carbon, graphite, carbon black, carbon nanotubes (CNT), copper, aluminum, nickel, other metals, metal oxides, polymers, conductive or non-conductive additives, or any combinations thereof.

Composite Materials with Conductive Materials (Particle Sizes and Distribution)

In some implementations, the composite material layer may include one or more non-smooth or non-uniform surface regions along the upper surface of the composite material layer. This surface roughness of the composite material layer may be adjusted by configuring the type and dispersion of conductive carbons that include, for example, and not limited to, graphite, carbon black, CNT, or by incorporating solid particles as particulate roughening agents, or any combinations thereof. In certain embodiments, the non-smooth or non-uniform surface of the composite material layer coating can promote improved spreading quality of electrode powders at high deposition speeds (high line speeds) whereby deposited powder adheres to the roughened surface at high line speeds. As is readily contemplated, other materials may be deposited and adhered to the upper roughened surface of the composite material layer at high line speeds, for example. In some embodiments, the particle sizes and distributions added to the composite material may be configured to generate roughness upon composite layer formation. In other words, the composite material may be configured to have a distribution of various particles and particle sizes (i.e., per volume of composite material) such that the deposition of the composite material formulation results in a composite material layer having non-smooth or non-uniform surface regions to facilitate adhesion of material deposited thereon.

In various implementations, the composite material particle sizes (i.e., composite material component particle sizes) may be defined in the range of 1-10 μm (D10-D90) in diameter. In various implementations, the particle sizes of the composite materials may be defined in a range from 0.10 μm to 30 μm in diameter and can be varied and controlled to generate a composite material layer with surface roughness. Moreover, the composite material formulation may contain conductive carbon species, for example, graphite, carbon black, CNT, or any combinations thereof, that can be added to modulate surface roughness. As is readily contemplated, composite material components may be selected based on inherent ranges of particle sizes and morphologies. In one implementation, the composite material may be configured to include a conductive carbon species such as graphite which comes in many different particle sizes and morphologies. The composite material can also include carbon black which is typically present as agglomerates and aggregates of extremely small primary particles (<100 nm). By modulating the processing parameters (shear rate, time), the degree to which these agglomerates and aggregates are broken down can be varied, altering the particle size distribution and changing the surface roughness. Selecting graphite of particle morphologies or particle size distributions, the surface roughness can be altered. As another example, carbon conductor such as CNT may be implemented such that the particle is resilient to pressure and/or heated at a calendering stage.

In a further aspect of the disclosure, the composite material may be configured to include a volume fraction of a composite material component described herein. In some embodiments, the composite material may include dry materials used to form a cathode, an anode, an electrode, solid-state battery separator, or other electrical (e.g., battery or non-battery) component as described herein. As an example, the composite material may be configured to include carbon, whereby a volume fraction (V_{F}) of carbon (V_{M}) within a volume of composite material (V_{C}) may be defined in a range from 15% to 70%, the volume fraction (V_{F}) being defined as:

$${V}_{F} = \frac{{V}_{M}}{{V}_{C}} ;$$

Where VE is defined as the volume fraction of a composite material component, for example, dry material (carbon), V_{M} is defined as the volume of the composite material component (i.e., carbon), and V_{C} is defined as the total volume of the composite material. As another example, in some implementations, the composite material may be configured to include a roughening agent (e.g., solid particles, roughening and anti-blocking agents, etc.,), whereby the volume fraction of the roughening agent within the composite material may be defined in a range from 1/25 to ¼, or 4% to 25%. Further, in some implementations, the volume fraction of a composite material component may be defined in a range from 1/25 to ½.

In a further aspect of the disclosure, the composite material may be engineered as described herein to provide a desired tackiness when deposited (or processed/conditioned) on the substrate (e.g., current collector substrate) as a composite material layer. In various implementations, one or more materials (polymers, particles or particulates may be added to the composite material layer to alter the tackiness of the composite material layer. The tacky composite material layer may be configured to increase the friction between the composite material layer top surface and the deposited material (e.g., dry powder) thereon, thereby enhancing the material (e.g., powder) spreading rate and the deposition uniformity. Further, the tacky composite material layer may increase the adhesion of a deposited material (e.g., dry powder) thereon to the substrate (e.g., current collector) In one implementation, the composite material may include a B-stage epoxy resin added into the composite material and/or added into the composite material layer. In some implementations, one or more regions of the upper surface of the composite material layer may be made tacky by coating one or more regions of the upper surface of the composite material layer with a B-stage epoxy resin. In certain implementations, the composite material may include a B-stage epoxy resin to form at least one tacky surface region. In some embodiments, the tackiness required may be in the low to medium tack range, 0.05 to 5 N/m when characterized with a probe tack tester. In various implementations, binders, solvents, plasticizers, resins (e.g., acrylic, epoxy, etc.,), surfactants, and the like, or any combinations thereof may be added to the composite material and/or composite material layer to increase the tackiness of the upper surface of the composite material layer to receive and adhere material deposited thereon.

In some embodiments, tacky materials (particles or particulates) may be added with roughening agents to the composite material layer to create one or more tacky regions and one or more non-smooth micro-surface regions. In some implementations, one or more tacky regions may be formed in place of one or more non-smooth micro surface regions based on the material deposited on the composite material layer. As is readily contemplated, in some implementations, the one or more tacky materials may be introduced to certain areas, edges, sections, or quadrants of the substrate being processed and conditioned based on the materials deposited, substrate material, smoothing roller, conditioning roller, and calender properties and recipes. Further, processing of a composite material with roughening agents and a composite material with tacky materials may be used interchangeably as described herein. For example, particle shapes, sizes, heating, compaction/pressing via calendering, addition of additives, binders, and other composite material layer components of a composite material layer with roughening agents (solid particles/polymers) may be applied to a composite material layer having tacky materials (i.e., a B-stage epoxy resin).

Composite Materials with Non-Conductive Agents/Materials (Morphology and Anisotropy)

In a further aspect of the disclosure, composite material components may include solid particles that may be added to the composite material to facilitate formation of one or more non-smooth or non-uniform micro-surface regions along the upper surface of the composite material layer. In some implementations, the solid particles can include a range of materials, including but not limited to, roughening agents such as thermoplastic polymers, thermosetting polymers, ceramics (metal oxides), glass, metal powders, or combinations thereof. In one embodiment, solid particles that may be added to the composite material to facilitate formation of one or more non-smooth or non-uniform micro-surface regions may be referred to as roughening agents.

In a further aspect of the disclosure, some factors for selection of roughening agents can include functional characteristics, morphology, and anisotropy (e.g., spherical, globular, ellipsoid, or irregularly shaped), density, thermal properties, cost, safety, dispersion stability, cohesion, and adhesion. chemical stability, and sourcing stability. In certain embodiments, the roughening agent may be conductive and may include, for example, silver-coated glass spheres and bubbles, and other agents as described herein. In some embodiments, the roughening agent may be non-conductive.

In one embodiment, the roughening agent may include one or more thermoplastic polymeric agents, such as micronized waxes, that may be low density, easily sourced, low cost, and supplied pre-dispersed. In certain embodiments, the roughening agent may include one or more thermosetting polymeric agents, such as crosslinked PMMA microspheres, that may be low density, have tightly controlled particle size distributions, and have good thermal stability. In some embodiments, the roughening agent may include one or more ceramic materials, such as silica or glass spheres, that may be extremely strong and extremely heat stable and can be found in specific morphologies. In some embodiments, a combination of roughening agents may be implemented based on process requirements (e.g., low temperatures), particle size distributions, and dispersion stability. The roughening agent particle sizes may be defined in the range of 1-10 μm (D10-D90) in diameter. In various implementations, the roughening agent particle sizes may be defined in a range from 0.10 μm to 30 μm in diameter and can be varied and controlled to generate a composite material layer with surface roughness.

Composite Materials with Carbon-Coated Microspheres

In a further aspect of the disclosure, composite material components may include solid polymer spheres with a layer of conductive carbon on an exterior surface of the solid polymer sphere. In certain implementations, the solid polymer may have a non-spherical shape and may be globular, ellipsoid, or irregularly shaped. In one implementation, a composite material component may include solid polymer microspheres applied with a thin coating of a conductive material (e.g., conductive carbon). The solid polymer spheres may be added to the composite material formulation to facilitate surface roughness for the composite material layer. In other words, solid polymer spheres may also be referred to as a roughening agent as described herein. In many embodiments, solid polymer spheres may be used as a roughening agent to facilitate a range of surface morphologies based on solid polymer sphere particle sizes and distributions. In one implementation, the substrate may be a conductive substrate (e.g., current collector) and the roughening agent (e.g., solid polymer sphere) may include a conductive coating to facilitate or improve conductivity of the composite material layer formed on the substrate. In various implementations, the conductive coating thickness may be defined in a range from 0.1% to 20% of the roughening agent particle size diameter. In various implementations, the conductive coating thickness may be defined in a range from 0.1% to 20% of the thickness of the roughening agent in cases where the solid polymer is of a non-spherical shape. In some embodiments, the conductive coating layer may cover an entire exterior surface of the solid polymer. In some embodiments, the conductive coating layer may partially cover the exterior surface of the solid polymer. In one embodiment, the polymers can be cross-linked to improve chemical stability and thermal properties.

In one implementation, a coating of conductive carbon (e.g., amorphous carbon black) may be applied to the surface of an insulative polymer microsphere. In some embodiments, the carbon coated polymer microsphere can provide a roughened surface. Further, adding carbon coated polymer microspheres to the composite material formulation may allow for controlled surface morphology of the composite material layer without compromising the conduction of the deposited material to the substrate via the composite material layer. In battery current collector applications, this can be one important factor, as the roughening agent will provide a significant portion of the contact area with the electrode layer (e.g., deposited material) and facilitate electrical conduction at the interface between the current collector and the electrode layer.

In various implementations, the conductive coating may be applied to the solid polymer microsphere by a mechanical means (e.g., mechanofusion, mechano-chemical reactions, etc.,) or electrostatic means (e.g., solution-based processes) as is known in the art. In some implementations, application of a conductive carbon layer on the solid polymer microsphere can be achieved by a number of different means. As an example, dry processing methods may be used, including rotor-stator milling or ball milling to apply the coating without the use of solvents. As another example, wet application methods can be used, including electrostatic attractions to apply the carbon to the polymer microparticles in aqueous or solvent media/medium. In one implementation, spray drying may be used to coat an exterior surface of the microsphere (e.g., solid polymer particle). In some implementations, carbon selection may include high specific surface area carbon blacks (SSA>40 m²/g) to minimize the effects on density and particle morphology. Moreover, in some implementations, carbon nanotubes may be used to provide a similar functionality at low deposited material loadings. Other variables include the ratio of carbon to solid polymer microsphere, or the ratio of mass to surface area will change depending on particle size. In various implementations, the volume ratio of carbon to solid polymer microsphere of the composite material may be defined in a range from 1:4 to 1:3.

In certain implementations, a composite material layer may include a plurality of composite material components (e.g., roughening agents, solid particles, conductive coated solid particles, etc.,) whereby an exterior surface of one or more roughening agents and solid particles protrudes out from an upper surface of the composite material layer as shown in FIGS. 4A-4B and 5A-5B. In some embodiments, the solid polymer diameter (or thickness) may be greater than the thickness of the composite material layer such that the exterior surface of the solid polymer sphere forms a significant portion of the contact area of the upper surface of the composite material layer. The contact surface of the composite material layer can thus be made to have a plurality of non-smooth surface regions for receiving and adhering a deposited material (e.g., dry powder, loose dry powder, etc.,) at high line speeds. Further, a volume of composite material may be configured to have significant amounts of solid polymer spheres to facilitate formation of a composite material layer having a plurality of non-smooth micro-surface regions. Moreover, such a composite material formulation can be made in advance and effectively applied to the substrate in one pass.

As described herein, the roughening agent can provide a significant portion of the contact area with the material deposited and processed (e.g., dry powder processed into an electrode layer). Therefore, a lack of conduction at this interface (e.g., electrode layer to current collector) can drive major changes in the electronic behavior of the final electrode assembly, even if bulk conductivity is not significantly affected. In various implementations, a percentage of effective contact area of non-smooth micro-surface regions (C_{A}) on a composite layer may be defined as the sum of exposed exterior surfaces of a roughening agent SAR (or the effective surface area covered by exposed exterior surfaces of the roughening agent) divided by the surface area of a composite material layer under consideration and having non-smooth micro-surface regions SA_{C} and can be defined as:

$${C}_{A} = \frac{{SA}_{R}}{{SA}_{C}} .$$

In various implementations, the percentage of effective contact area of non-smooth micro-surface regions C_{A} may be defined in a range from 8% to 75%.

In some implementations, the protruding exterior surface of each of the roughening agents contributes to the effective surface area SAR covered by the roughening agent, thus, C_{A} may be considered as the density of protruding exterior surfaces for powder to contact and adhere. Conductive microparticles, typically consisting of metal (Ag, Cu, Ni, Al) coatings on inorganic particles (e.g., glass microspheres), may be commonly used in high value conductive coatings and adhesives. However, these conductive coatings and adhesives are typically quite expensive due to complexity of manufacturing and high raw material costs. In addition, the density of these materials is typically quite high (>4 g/mL) and the metallic coatings can catalyze reactions under certain conditions, including those found within lithium-ion batteries. Alternatively, polymer microspheres, for example, Poly(Methyl Methacrylate) (PMMA), are readily available and provide lower densities and wider range of available particle sizes. Further, solid polymer chemical stability, such as improved thermal properties, can be achieved via crosslinking. For example, PMMA particles can be coated with conductive metal coatings (same as ceramics) for improved thermal properties. Moreover, carbon coating of these polymer microspheres can provide a conductive material without compromising density, cost, or compatibility, if carbon materials known to be compatible in the electrochemical cells in which it is utilized.

### Surfactant, Wetting Agent

In some embodiments, the substrate surface may be conditioned to facilitate adhesion of subsequently deposited or coated materials. For example, a wetting agent or surfactant may be deposited on a surface of the substrate to reduce the surface tension of subsequently coated or deposited fluids and composite materials. In some implementations, the wetting agent or surfactant may be added to the composite material(s) or coated with the composite material(s). The wetting agent may disrupt the interaction (e.g., hydrogen/polar bonding) that drives fluid surface tension. As an example, the wetting agent may be applied as an additive to improve wetting of slurries onto metal current collectors. While adhesion can be improved using a wetting agent, it can be readily contemplated that surface conditioning may provide other benefits such as reduction/elimination of defects of deposited materials, and others as described herein. In some embodiments, the wetting agent may interact with the composite material to reduce cratering defects, picture framing defects, and edge splattering defects associated with composite material layer formation. These defects are typically driven by the instability of the thickened edges of the composite material layer on the substrate. An example wetting agent may include PDMS (polydimethylsiloxane), a hydrophobic material, that may be used to modify the substrate surface to improve its wettability, allowing liquids to spread and adhere more easily. Moreover, plasma surface treatment, Corona Discharge Treatment (CDT), or the like, or any combinations thereof may be applied to treat the substrate surface for composite material layer deposition or coating. The composite material may be deposited onto the wetting agent for stronger adhesion to the substrate. The wetting agent thickness and loading may be adjusted as desired to reduce defects, for example. As is readily contemplated, rheological modification or increased wetting agent loading may allow for further edge quality improvement.

### Binders (Multi-/Cross-Linked Binders)

In a further aspect of the disclosure, in some implementations, the composite material may include, or be subsequently coated with, one or more binders configured to have at least one thermal activation property. In one embodiment, the composite layer 220 may include a binder configured to promote adhesion of particles within the composite layer (e.g., composite material) to a substrate surface. The binder may be thermally activated at a predetermined temperature to promote adhesion. In certain implementations, a printing apparatus may add one or more binders to the composite material on one or more surfaces of the substrate during processing, then thermally activate the binder to promote adhesion of the composite material to the substrate. In various implementations, a low temperature thermally activated binder may be defined to become activated in a temperature range from 25 °C to 90 °C, a moderate temperature thermally activated binder may be defined to become activated in a temperature range from 90 °C to 150 °C, a high temperature thermally activated binder may be defined to become activated in a temperature defined as above 150 °C, and preferably in a range from 150 °C to 225 °C. Some examples of binders that may be added to the composite material include, but not limited to, Thermoplastic Elastomers (TPE), Styrene-Ethylene-Butylene Copolymer (SEBS), Acrylic-Acid Grafted High-Density Polyethylene (AAHDPE), Low-Density Polyethylene (LDPE), and Polymer Emulsions (e.g., Fluorinated polymer emulsion). As one example, the composite material binder may be configured to include a self-crosslinking acrylic polymer having resistance to heat and light aging, wet strength, chemical resistance, and a level of hardness/stiffness in order to promote adhesion to surface moisture of a coated substrate.

In some embodiments, the composite layer 220 may include a low temperature binder and the composite film 225 may include a high temperature binder. The low temperature binder may be activated to adhere to a deposited material deposited on the composite layer 220 then the high temperature binder may be activated to adhere to a deposited material deposited on the composite film 225. Alternatively, the high temperature binder within composite film 225 may be activated first by application of high temperature heating, then the low temperature binder within the composite layer 220 may be activated by application of low temperature heating. It follows, that the high temperature binder may be configured to be activated upon high temperature heating such that the substrate 210, composite layer 220, and composite film 225 when heating using low temperature heating would active binder in the composite layer 220 but not in the composite film 225.

In certain embodiments, the composite layer 220 may include two or more binders, whereby each binder is configured to have a unique or distinct range of thermal activation and other properties as described herein. In certain implementations, the composite layer 220 may include at least two binder materials, a low temperature binder and a high temperature binder. The low temperature binder within the composite layer 220 can become paste-like when thermally activated at low temperatures thereby promoting adhesion to a surface or material deposited thereon without activating the second binder. Further, the high temperature binder within the composite layer 220 can become paste-like when thermally activated at high temperatures thereby promoting adhesion to a surface or material deposited thereon at a subsequent processing or conditioning stage. Moreover, a low temperature binder may be implemented to facilitate adhesion of the composite material to the substrate, while the high temperature binder may be used to facilitate spreading and cohesion of material deposited thereon.

In a further aspect of the disclosure, each binder material may be configured to activate based on a particular conditioning process (e.g., heating, compaction/spreading, etc.,) such that the configured binder facilitates desirable interactions between the substrate and material deposited thereon during that particular conditioning process. For example, a low temperature binder on one surface of the substate may become paste-like to promote adhesion of a deposited material thereon while keeping another binder of higher activation temperature on an opposite surface of the substate from becoming paste-like and sticking to a stationary or moving surface (e.g., a powder uniformization device) during a conditioning process. Moreover, both low and high temperature binders may be configured to have sufficient adhesion to the substrate during a conditioning process that operates on both binders. In certain embodiments, the composite layer 220 and the composite film 225 may be exposed to significant heat and pressure prior to being adhered to a deposited material.

In some implementations, the composite material may include, or be subsequently coated with, one or more UV curable binder materials. The UV curable binder materials may be included in the composite material as a liquid monomer that functions as a liquid vehicle to disperse the conductive carbons and additives. By using UV curable binder, the use of solvent and water can be eliminated from the composite material thereby saving costs and being more environmentally friendly.

In one implementation, the binder may be configured as a cross-linked binder. The cross-linked binders may be polymer binders where the polymer chains are linked together, creating a three-dimensional network structure. The cross-linked binders may improve mechanical properties (e.g., strength, resistance to stress and deformation, and elasticity), adhesion of the deposited material, electrode stability (e.g., preventing pulverization and cracking of the active material), cycling performance (e.g., better capacity retention and longer cycle life), and provide self-healing (e.g., containing reversible bonds to allow damage repair during cycling). Some examples of cross-linked binders include Citric Acid (CA) and Carboxymethyl Cellulose (CM C), Polyoxadiazole (POD) with Glycerol (GL), Polyacrylic Acid (PAA) and β-cyclodextrin (β-CD), Polyacrylonitrile (PAN) Hydrolysate (H-PAN) with epichlorohydrin (ECH), Sodium Alginate (SA) cross-linked with Citric Acid (CA), Cross-linked Chitosan, Cross-linked Poly(acrylic acid) (PAA) with Poly(ethylene glycol) (PEG), and so forth.

### Anti-Blocking Agents

In certain implementations, anti-blocking agent may be added to the composite material formulation as a composite material component. The anti-blocking agent may be added to the composite material layer to prevent adhesion or stiction of the composite material layer to a powder uniformization device. The anti-blocking agent would not affect the generation of electrode adhesion by the composite material layer during calendaring due to the high pressure/temperature used during the calendaring stage. A high or moderate pressure may be sufficient to prevent the anti-blocking agent from affecting electrode adhesion (e.g., deposited adhesion). In some embodiments, the anti-blocking agent can be selected so as to melt under high/moderate temperature and/or pressure during a second-pass calendaring. In some embodiments, the anti-blocking agent may be a polypropylene matting agent, for example.

### Adhesion Conditioning

In many implementations, the composite material may be heated and/or dried after deposition to improve adhesion to a surface of a substrate 210. The composite layer 220 and the composite film 225 may be heated or dried using an oven drying process having an oven temperature of 100 °C or less. For example, the substrate 210 may be spray coated with a composite material then positioned in, or transported through, an oven to dry and facilitate adhesion of the composite material to the substrate 210. The heating process can facilitate adhesion of the composite material layer to a substrate and reduce or eliminate delamination of the composite material layer from further processing of the substrate 210 from, for example, vacuum bristle abrasion. In certain implementations, the flow rate (or pump speed) of composite material deposition may be increased to resolve coating defects (e.g., ribbing defects of the composite material layer) for thinner wet film thickness (WFT) coatings of the composite material. In some embodiments, a vacuum box may be implemented to reduce or eliminate ribbing defects.

### Composite Material Processing

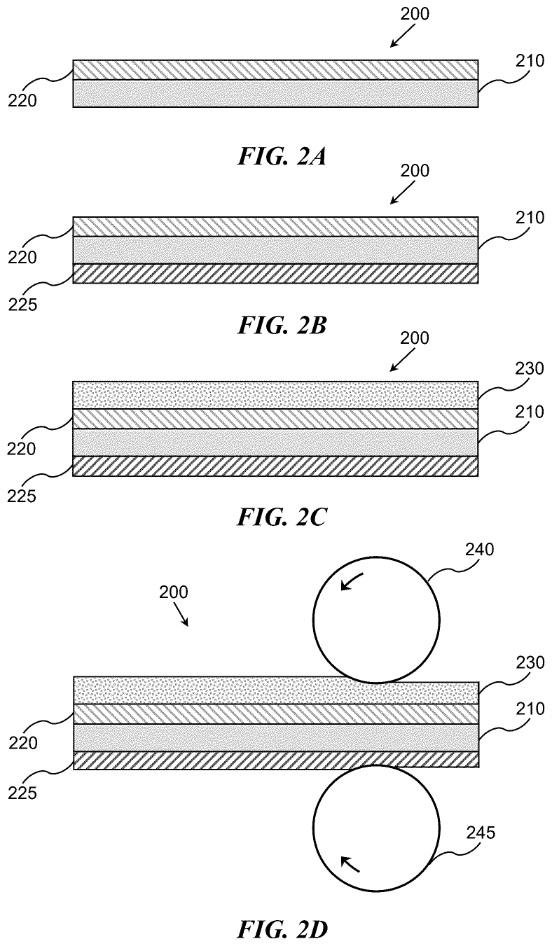

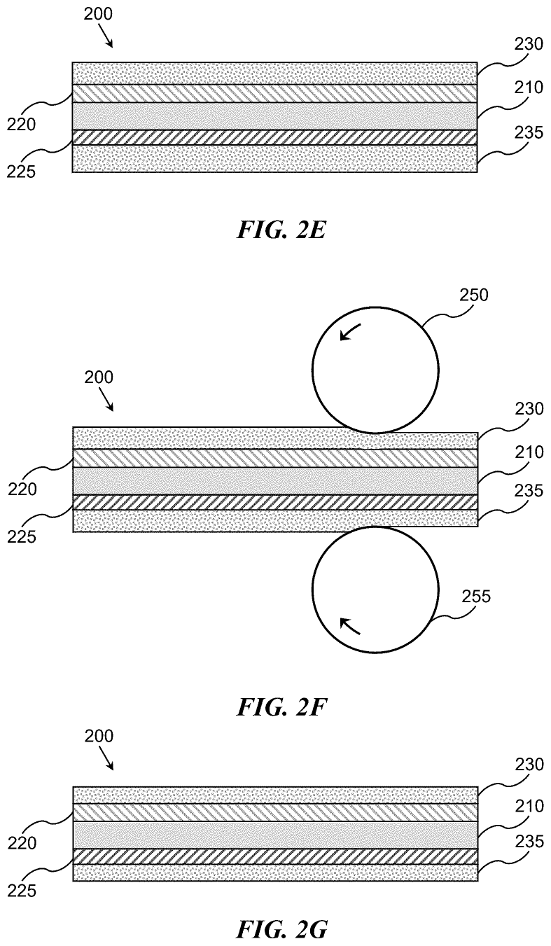

With reference to FIGS. 2A-2G, a multi-step composite material deposition and processing 200 is shown. The multi-step composite material deposition and processing 200 may include a substrate 210, a composite layer 220, a composite film 225, a material 230 (e.g., dry powder) deposited on the composite layer 220, a material 235 (e.g., dry powder) deposited on the composite film 225, and conditioning devices, for example, powder uniformization devices 240, 245, 250, and 255 configured to condition and/or process substrate 210, composite layer 220, composite film 225, and materials 230, 235 deposited thereon. In a further aspect of the disclosure, the composite material may be coated and processed on a ceramic substrate, a polymer substrate, a separator substrate, or within a process step as a transport substrate or sacrificial substrate. Moreover, the composite material layer may be implemented as an interfacial adhesion layer or sacrificial layer as desired within a process of manufacturing batteries or within the end product of manufacturing batteries including lithium-ion batteries, solid-state lithium-metal batteries, and so forth. In one implementation, a composite layer 220 and a composite film 225 may be deposited on opposite surfaces of the substrate 210 and configured separately such that the composite layer 220 and the composite film 225 may be processed or conditioned differently based on the material deposited, the configuration of conditioning devices, and the surface or material properties of substrate 210, or any combinations thereof. In one implementation, the composite material processing 200 and the composite materials described herein may be deposited, conditioned, and processed using the printing apparatus 100 of FIG. 1 or another printing apparatus. For example, the composite material processing 200 and the composite materials described herein may be deposited, conditioned, and processed using a station-to-station printing apparatus configured for depositing and processing the composite material layer and materials (e.g., dry powder) deposited thereon at each station and transferring the product to another station for further processing.

In a further aspect of the disclosure, in some embodiments, the composite material layer surface properties may be used as a target substrate whereby a material (e.g., dry powder) may be selected, deposited, and processed thereon based on the composite material formulation. Further, the printing apparatus can be configured to facilitate deposition of the composite material layer and processing of the composite material layer as the substrate. Consequently, in some embodiments, the composite material layer may be deposited on both sides of a substrate and configured for single-sided material (e.g., dry powder) deposition and processing as shown in FIGS. 2A-2D. In certain embodiments, the composite material layer may be deposited on both sides of a substrate and configured for dual-sided material (e.g., dry powder) deposition and processing as shown in FIGS. 2E-2G. As can be readily contemplated, a first material (e.g., dry powder) may be deposited on a first composite material layer located on a first surface of the substrate, and a second composite material layer and a second material may be deposited on a second surface of the substrate. In some implementations, the first composite material may be different from the second composite material and the first deposited material may be different from the second deposited material. In certain implementations, the first and second composite material layers may be deposited simultaneously, consecutively, concurrently, or sequentially. Further, the first and second materials (e.g., dry powder) may be deposited simultaneously, consecutively, concurrently, or sequentially on the corresponding composite material layer. As an example, the first and second materials can have different compositions or formulations thereby resulting in different properties for desirable interaction with the composite material and substrate. Moreover, the first and second composite material layers can have different compositions or formulations thereby resulting in different properties for desirable interaction with the substrate and materials deposited on the composite material layer.

### Processing Single-Coated Substrate, Single-Sided Material

With reference to FIGS. 2A, 4B, and 5B, in one implementation, the composite material formulation may include solid particles or one or more solid particle dispersions of the same or different material(s). The solid particle dispersion can facilitate formation of a composite material layer having a plurality of roughened surface regions as shown in FIGS. 4B and 5B. The surface roughness of the composite material layer may be sufficient to facilitate spreading and adhesion of material deposited thereon. As can be readily contemplated, a single or multiple coatings of composite material can be applied on at least one surface of the substrate to obtain a desired thickness. In various implementations, the thickness of the composite material on a single-coated substrate may be defined in a range from 1 μm-50 μm. In certain implementations, a surface roughness of the composite layer 220 (or composite film 225) may be configured to be of a preferred ratio to the thickness of the composite layer 220 (or composite film 225). In some embodiments, the surface roughness of the composite layer 220 may be defined as the thickness of a roughening agent extending out from the composite layer 220. As an example, the surface roughness of the composite layer 220 may be defined in a range from 0.5 μm-2 μm (i.e., the thickness of the protruding portion of the roughening agent(s) from the composite layer 220), and the composite layer 220 thickness may be defined in a range from 1 μm-50 μm to yield a ratio of composite material layer thickness to surface roughness thickness of 1:2 to 100:1 based on the substrate material and material deposited.

In various implementations, the surface roughness thickness of the composite film 225 may be defined in a range from 0.5 μm-2 μm, and the composite film 225 thickness may be defined in a range from 1 μm-10 μm to yield a ratio of composite material layer thickness to surface roughness thickness of 1:2 to 20:1 based on the substrate material and material deposited. Moreover, the composite material can be further deposited on substrate regions adjacent to existing materials deposited and/or processed as desired. The substrate may be made of any metal, plastic, ceramic, polymer, or glasses so long as the formulation of the composite material includes additives, binder, and solvent/solution to facilitate adhesion of a material deposited thereon. Moreover, the material deposited can be other than dry powder or loose dry powder, the material deposited may form an electrical contact. Additionally, the substrate and material deposited may form a component that facilitates an electrical contact such as a solid-state battery separator, as an example. In one embodiment, the finished/processed substrate may be implemented as a separator in a solid-state battery. In certain embodiments, the composite material itself may be transferred from one substrate (e.g., metal substrate) to another (e.g., glass or polymer substrate). As can be readily contemplated, the composite material layer thickness and surface roughness described above may be applied to various embodiments described herein and can be adjusted based on the substrate material and properties, and the material deposited on the composite material layer as described herein.

### Processing Dual-Coated Substrate, Single-Sided Material

Referring to FIGS. 2A-2D, an illustration of one embodiment of processing a substrate including dual-sided composite material and single-sided material (e.g., dry powder) deposition, in accordance with aspects of the present disclosure. With reference to FIGS. 2A-2G, in some implementations, the composite material layer may be configured to facilitate desirable interactions with the material (e.g., dry powder) deposited on the composite material layer (e.g., improved adhesion, spreadability, cohesion, and conductivity to substrate). Moreover, the composite material layer can be configured to facilitate desirable interactions between the material (e.g., dry powder) deposited thereon and one or more powder uniformization devices configured for spreading and/or compaction of the deposited material (e.g., improved adhesion and peel strength). In certain implementations, the composite material layer can be configured to facilitate desirable interactions between the material deposited (e.g., dry powder) thereon and one or more conditioning devices implemented to process the deposited material and the substrate (e.g., improved spreadability, cohesion, and surface uniformity). In some implementations, the composite material layer may be configured to facilitate desirable interactions between the composite material layer and powder uniformization device(s) and/or one or more conditioning devices implemented to process the composite material layer (e.g., improved stiction of composite material, resilience to smoothing and deformation from applied pressure and heat).

With reference to FIGS. 2A-2B, in one implementation, the composite material processing 200 may include depositing a composite material on a substrate to form a composite layer or film. In one embodiment, a composite layer 220 may be formed on a surface of a substrate 210 and a composite film 225 may be formed on an opposite surface of the substrate 210, whereby the composite film 225 and composite layer 220 sandwich the substrate 210. In some embodiments, the composite layer 220 and composite film 225 may be formed adjacent to one another and on the same surface of the substrate 210. Further, the composite layer 220 and the composite film 225 may coated, formed, or deposited on the substrate 210 simultaneously, consecutively, concurrently, or sequentially. Moreover, the composite film 225 may be deposited on the substrate 210, conditioned and prepared, prior to deposition of the composite layer 220 on the substrate 210. In many embodiments, the composite layer 220 and composite film 225 may be heated (e.g., dried) to a low or moderate temperature, for example. Moreover, in some implementations, the composite layer 220 and composite film 225 may include one or more binders and pre-heated to a temperature below binder thermal activation prior to conditioning (e.g., compaction and spreading by a powder uniformization device. In some implementations, the composite layer 220 may be deposited on a different surface region or offset on an opposite side of the substrate 210 from the composite film 225. In certain implementations, a composite layer 220 may be deposited in a separate process and conditioned or prepared prior to deposition of composite film 225. The substrate 210 may be selected based on the composition or processing/formulation of the composite layer 220 and/or composite film 225 and should not be interpreted as being limited to conductive or semiconductive materials. In one embodiment, the substrate 210 may be a current collector, the composite layer 220 may be coated on the top surface of the current collector, and the composite film 225 may be coated on the bottom surface of the current collector. Moreover, in some implementations, the composite layer 220 and composite film 225 may be coated/precoated on a roll or substrate. The precoated substrate may be loaded onto a station or conveying unit of a printing apparatus, processed, and then transported and collected at a reeling unit 175.

With reference to FIG. 2C, in one implementation, the composite material processing 200 may include depositing material 230 (e.g., dry powder) on the composite layer 220. The material 230 may be heated or warmed up using an oven, induction heating, or IR heating as described herein. In various implementations, the temperature of heating material 230 may be defined in a range of 100 °C or less. In one embodiment, the formulation of the composite material may include various components, for example, binders, co-binders, roughening agents, solid particles that when heated may facilitate, for example, improved adhesion and spreadability of deposited material and improved peel strength of the composite layer 220 to the substrate 210 at a calendering stage. Similarly, the composite film 225 may include a formulation of composite material including various components that facilitate, for example, improved adhesion and spreadability of deposited material and improved peel strength of the composite layer 225 to the substrate 210 at a calendering stage. Moreover, the composite layer 220 and composite film 225 may be configured with various particle sizes and distribution to facilitate, for example, increased surface roughness and/or increased the effective thickness of the composite material layers.

With reference to FIG. 2D, in one implementation, the composite material processing 200 may include conditioning of at least the deposited material 230 (e.g., dry powder) and the composite film 225. In one embodiment, the deposited material 230 and composite layer 220 may be heated to a moderate or high temperature and applied with a low pressure by a powder uniformization device 240. Further, the composite film 225 may be heated to a low or moderate temperature and applied with a low pressure by a powder uniformization device 245. In one embodiment, the deposited material 230 and composite layer 220 may heated prior to application of a moderate pressure by a powder uniformization device 240. In certain embodiments, the deposited material 230 and composite layer 220 may heated to a high temperature during application of a low pressure by a powder uniformization device 240. In some embodiments, the composite film 225 may heated to a moderate temperature during application of a low pressure by a powder uniformization device 245. In one embodiment, the composite film 225 may heated prior to application of a moderate pressure by a powder uniformization device 245.

In one implementation, the composite material layers may be configured to include one or more composite material components such as binders with distinct thermal activation properties. As an example, the composite layer 220 may be configured to include one or more low or moderate temperature thermal activation binders (e.g., with reduced/minimal thermal requirement) to ensure adhesion of the deposited material 230 to the composite layer 220 during compaction and spreading by powder uniformization device 240. Further, the composite film 225 may be configured to include one or more moderate or high temperature thermal activation binders to prevent surface defects or deformation of the composite film 225 during heating and pressure or compaction by powder uniformization device 245. Further, the one or more moderate or high temperature thermal activation binders may prevent adhesion of composite film 225 to powder uniformization device 245 during heating and compaction/spreading by powder uniformization devices 240, 245.

In many embodiments, each of the composite layer 220 and composite film 225 may include one or more composite material components, including and not limited to, roughening agents, solid-particles, anti-blocking agents, and so forth, or any combinations thereof. Further, the composite material components may be configured to have various sizes and distributions to facilitate a surface roughness of the composite material layer. These composite material components (e.g., roughening agents, solid particles and size/particle distributions, high thermal activation polymers, binders, etc.,) may be added to facilitate increased peel strength and adhesion (and reduced/elimination of stiction during compaction) of the composite material layer to the substrate, and increased non-smooth micro-surface regions (e.g., surface roughness) of the composite material layer to facilitate adhesion and spreadability of a deposited material (e.g., loose dry powder) on the composite material layer. Referring again to FIG. 2D, as an example, the composite film 225 may include a polymer with a high activation temperature to prevent adhesion of the composite film 225 to the powder uniformization device 245. Moreover, the composite material components of the composite film 225 may be selected and configured such that a surface roughness of the composite film 225 is maintained after heating, compaction and spreading by the powder uniformization device 245. The composite material components can enhance durability and improve the contact interface of the composite film 225 with the substrate 210 (e.g., current collector) and the deposited material 230 (e.g., dry powder processed to form electrode layers). Further, the composite layer 220 and the composite film 225 may have different properties based on the composite material components to improve deposited material (e.g., dry powder) interactions during power deposition, conditioning, and processing. As an example, at least one of the following properties of the composite layer 220 and the composite film 225 may be different: roughness, thickness, binder thermomechanical properties, binder chemistry and loading, conductive carbon type and loading, and anti-blocking agent chemistry and loading.

### Temperature Gradient and Substrate Temperature, Single-Sided Material

In a further aspect of the disclosure, in some embodiments, the application of different heating temperatures (vis-à-vis, based on one or more different binder materials and corresponding thermal activation temperatures) to the composite layer 220 and composite film 225 may form a temperature gradient between each powder uniformization device 240, 245 and each surface of the substrate 210. As an example, one side of the substrate 210, coated with a composite film 225, may be in direct contact and under significant pressure (moderate to high pressure) with a heated powder uniformization device 245. The formulation of the composite film 225 may be configured such that the physical and/or chemical properties of the composite film 225 do not change unfavorably and would not generate undesirable interactions between the composite film 225 and the heated powder uniformization device 245 as described herein.

In some implementations, the applied heating (high or moderate temperature) to the deposited material 230 and composite layer 220 may facilitate a substrate temperature that may be defined in a range from 120 °C to 175 °C. The temperature of the powder uniformization device 240 may be defined in a range from 150 °C to 225 °C. The temperature of the powder uniformization device 245 may be defined in a range from 90 °C to 150 °C. The temperature gradient between the powder uniformization device 240 and the deposited material 230 or between the powder uniformization device 245 and the composite film 225 may be defined in a range from 40 °C to 75 °C. In a further aspect of the disclosure, the substrate 210 may include a range of temperatures based on low, moderate, and high temperature application in addition to compaction and spreading by a powder uniformization device. The substrate 210 temperature may be defined in a range from 25 °C to 90 °C as a low temperature range. The substrate 210 temperature may be defined in a range from 90 °C to 150 °C as a moderate temperature range. The substrate 210 temperature may be defined in a range from 150 °C to 225 °C as a high temperature range. As is readily contemplated, the substrate temperature may also facilitate thermal activation of the composite material layer (i.e., composite layer 220 and/or composite film 225). Moreover, the temperature gradient can be configured to only activate the composite layer 220 and not the composite film 225.

Moreover, in certain implementations, the heating applied to the deposited material 230 may create a low to moderate temperature gradient between the top surface of the substrate 210, the composite layer 220, and the deposited material 230. In one implementation, the temperature gradient may be between 20 °C to 70 °C. Similarly, in certain implementations, the heating applied to the composite film 225 may create a moderate to high temperature gradient between the bottom surface of the substrate 210 and the composite film 225. In one implementation, the temperature gradient may be between 50 °C to 90 °C.

### Processing Dual-Coated Substrate, Dual-Sided Material

Referring to FIGS. 2E-2G, an illustration of one embodiment of processing a substrate including dual-sided composite material and material (e.g., dry powder) deposition, in accordance with aspects of the present disclosure. With reference to FIGS. 2D-2F, the one or more moderate or high temperature thermal activation binders of the composite film 225 may be configured to have sufficiently high thermal activation temperature to prevent stiction to a heated powder uniformization device 245, but still low enough to allow for adhesion of the deposited material 235 (e.g., dry powder) during compaction and/or spreading by the powder uniformization device 255. As described herein, composite material components may be added to either composite layer 220 and composite film 225 and may be configured to facilitate increased peel strength, reduced/elimination of stiction during compaction of the composite material layer, increased non-smooth micro-surface regions (e.g., surface roughness) of the composite material layer to facilitate adhesion and spreadability of a deposited material (e.g., loose dry powder) on the composite material layer, and so forth.

With reference to FIG. 2E, in one implementation, the composite material processing 200 may include depositing material 235 (e.g., dry powder) on the composite film 225. The material 235 may be heated or warmed up using an oven, induction heating, or IR heating as described herein. In various implementations, the temperature of heating material 235 may be defined in a range of 100 °C or less. In one embodiment, the formulation of the composite material may include various components, for example, binders, co-binders, roughening agents, solid particles that when heated may facilitate, for example, improved adhesion and spreadability of deposited material and improved peel strength of the composite film 225 to the substrate 210 at a calendering stage. The processed and conditioned material 230 may form a material layer such as an electrode layer, for example. Moreover, both composite layer 220 and composite film 225 are covered by material 230 and material 235, respectively and no longer in direct contact with a powder uniformization device. In some embodiments, the material 230 may also be heated or warmed up using an oven, induction heating, or IR heating as described herein. In various implementations, the temperature of further heating material 230 may be defined in a range of 100 °C or less.

With reference to FIG. 2F, in one implementation, the composite material processing 200 may include conditioning of at least the deposited material 235 (e.g., dry powder) and the composite film 225. In one embodiment, the composite layer 220, deposited material 230, composite film 225, and deposited material 235 may be heated to a moderate or high temperature and applied with a moderate or high pressure by a powder uniformization devices 250, 255. In one embodiment, the deposited material 230 and composite layer 220 may heated to moderate or high temperature and applied with a moderate to high pressure by a powder uniformization device 250. In certain embodiments, the deposited material 235 and composite film 225 may heated to moderate or high temperature and applied with low to moderate pressure by a powder uniformization device 255. In some embodiments, the composite material layers may be heated prior to application of pressure by a powder uniformization device as described herein.

### Temperature Gradient and Substrate Temperature, Dual-Sided Material

In a further aspect of the disclosure, in some embodiments, the application of different heating temperatures (vis-à-vis, based on one or more different binder materials and corresponding thermal activation temperatures) to the deposited material 230 (e.g., dry powder) and deposited material 235 (e.g., dry powder) may form a temperature gradient between each powder uniformization device 250, 255 and each surface of the substrate 210. As described herein, the formulation of the composite film 225 and composite layer 220 may be configured such that the physical and/or electrochemical of the composite film 225 and composite layer 220 do not change unfavorably and would not generate undesirable interactions between the deposited material 235 and the deposited material 230 and the heated powder uniformization devices 240, 245, 250, and 255 as described herein.

In some implementations, the applied heating (high or moderate temperature) and pressure (moderate to high) to the deposited material 230 and the deposited material 235 may be substantially similar such that a temperature and pressure gradient is minimal. As is readily contemplated, the substrate temperature may be substantially similar to the powder uniformization device 250 that may be defined in a range from 150 °C to 225 °C, and the powder uniformization device 255 that may be defined in a range from 150 °C to 225 °C. In one embodiment, the deposited material 230 may be applied with a temperature of between 180 °C-200 °C during application of high pressure by the powder uniformization device 250. In certain embodiments, the deposited material 230 may be applied with a temperature of between 180 °C-200 °C during application of high pressure by the powder uniformization device 255.

Moreover, in certain implementations, the heating applied to the deposited material 230 may create a zero-temperature gradient between the top surface of the substrate 210, the composite layer 220, and the deposited material 230. In one implementation, the temperature gradient may be between 0 °C to 10 °C. Similarly, in certain implementations, the heating applied to the deposited material 235 may create a zero-temperature gradient between the bottom surface of the substrate 210, the composite film 225, and the deposited material 235. In one implementation, the temperature gradient may be between 0 °C to 10 °C.

The composite film 225 may be activated by the application of high/moderate temperature and high/moderate pressure of the powder uniformization device 255. The deposited materials 230, 235 may be in a state where the substrate 210 interaction is dependent on tribological properties (friction, wear, and lubrication) of the powder uniformization devices 250, 255 and the composite layer 220 and composite film 225. Therefore, it is necessary to introduce composite material components that remain during application of heat and pressure such that materials 230, 235 may be deposited at high line speeds and in fluid or fluidized state to spread and adhere to the substrate 210. Moreover, the composite material components may be needed to facilitate improved peel strength and adhesion of the deposited materials 230, 235 to the substrate 210 during compaction and heating by the powder uniformization devices 250, 255. In some embodiments, an anti-blocking agent may be added to the composite film 225 such that application of high pressure and high heat by the powder uniformization device 255 melts the anti-blocking agent to facilitate adhesion of the deposited material 235 to the bottom surface of the substrate 210.

With reference to FIG. 2G, in one implementation, the composite material processing 200 may include further conditioning of at least the deposited material 230 (e.g., dry powder) and deposited material 235 (e.g., dry powder). In one embodiment, the composite material may be implemented as a substrate whereby material 230 and 235 are deposited on the composite layer 220 and composite film 225, respectively, and conditioned and processed as the substrate as described herein. In one implementation, the material 230 and material 235 may be further heated or warmed up using an oven, induction heating, or IR heating as described herein. In various implementations, the temperature of heating materials 230, 235 may be defined in a range of 100 °C or less. In some implementations, the material 230 and material 235 may be further applied by a high or moderate temperature and high or moderate pressure by one or more powder uniformization devices.

### Method of Forming and Processing Composite Material Layers

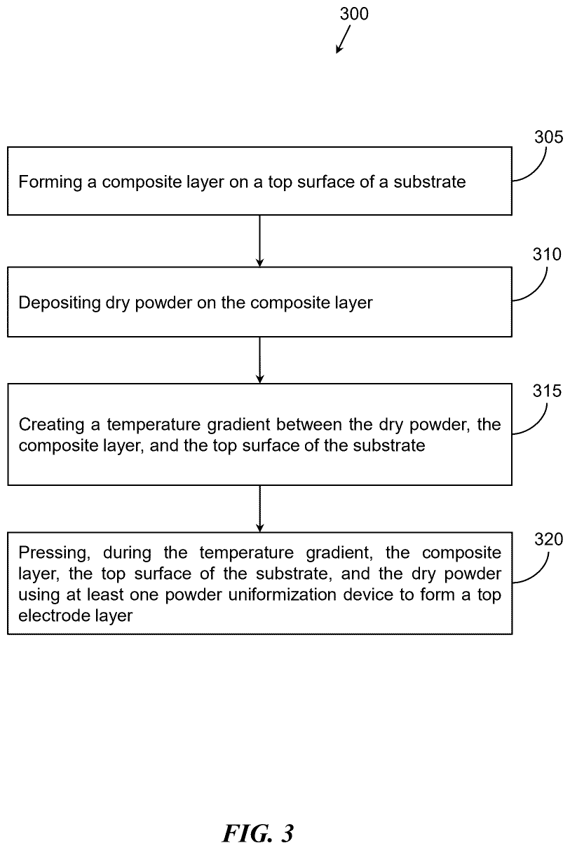

FIG. 3 illustrates an example flowchart showing a method of depositing and processing a composite material layer configured to facilitate desirable interactions between the composite material layer formed on a substrate, a material (e.g., dry powder) deposited on the composite material layer and powder uniformization devices configured to process the deposited material and substrate, in accordance with one or more embodiments of the present disclosure.

These exemplary methods are provided by way of example, as there are a variety of ways to carry out these methods. Each block shown in FIG. 3 represents one or more processes, methods, or subroutines, carried out in the exemplary method. FIGS. 1, 2A-2G, 4A-4B, 5A-5B, and 7 show example embodiments of carrying out the method of FIG. 3 for facilitating desirable interactions between a composite material layer formed on a substrate, a material (e.g., dry powder) deposited on the composite material layer and powder uniformization devices configured to process the deposited material and substrate. Each block shown in FIG. 3 represents one or more processes, methods, or subroutines, carried out in the exemplary method. The exemplary method may begin at block 305. Method 300 may be used independently or in combination with other methods or process for facilitating desirable interactions between the composite material layer formed on a substrate, a material (e.g., dry powder) deposited on the composite material layer and powder uniformization devices configured to process the deposited material and substrate. For explanatory purposes, the example process 300 is described herein with reference to the printing apparatus and composite material processing of FIGS. 1, 2A-2G, 4A-4B, 5A-5B, and 7. Further for explanatory purposes, the blocks of the example process 300 are described herein as occurring in serial, or linearly. However, multiple blocks of the example process 300 may occur in parallel. In addition, the blocks of the example process 300 may be performed a different order than the order shown and/or one or more of the blocks of the example process 300 may not be performed. Further, any or all blocks of example process 300 may further be combined and done in parallel, in order, or out of order.

In FIG. 3, the exemplary method 300 of facilitating desirable interactions between the composite material layer formed on a substrate, a material (e.g., dry powder) deposited on the composite material layer and powder uniformization devices configured to process the deposited material and substrate. M method 300 begins at block 305. In block 305, the method includes forming a composite layer on a top surface of a substrate. In block 310, the method includes depositing dry powder on the composite layer. In block 315, the method includes creating a temperature gradient between the dry powder, the composite layer, and the top surface of the substrate. In block 320, the method includes pressing, during the temperature gradient, the composite layer, the top surface of the substrate, and the dry powder using at least one powder uniformization device to form a top electrode layer.

In some embodiments, the method 300 may further include heating the top electrode layer during application of pressure by the at least one powder uniformization device. Further, in some implementations, the method 300 may include forming a composite film on a bottom surface of the substrate opposite to the top surface. The composite film may be conditioned/processed, for example, heated and adhered to the substrate to facilitate improved adhesion and peel strength of a dry powder deposited on the bottom surface of the substrate. The method 300 may further include heating the composite film or preheating the composite film to a temperature below activation prior to applying pressure to the composite film by a second powder uniformization device. Moreover, the material deposited can be other than dry powder or loose dry powder, the material deposited may form an electrical contact. Additionally, the substrate and material deposited may form other components such as a solid-state battery separator, as an example. In certain embodiments, the composite material itself may be transferred from one substrate (e.g., metal substrate) to another (e.g., glass or polymer substrate).

Composite Materials with Non-Conductive Agents/Materials

Referring to FIGS. 4A-4B, an illustration of one embodiment of composite material components configured to facilitate desirable interactions between a composite material layer formed, a material (e.g., dry powder) deposited on the composite material layer, and powder uniformization devices configured to process the deposited material and composite material layer, in accordance with aspects of the present disclosure. In one embodiment, a composite material component may include solid particles 400. The solid particles 400 may include, for example, and not limited to, a spherical polymer 405, an irregularly shaped polymer 410, an ellipsoid polymer 415, and a flattened polymer 425. In certain implementations, the composite material component may include solid particles with a coating, for example, and not limited to, a polymer sphere 430 with a coating 435 (e.g., conductive, or non-conductive), an irregularly shaped polymer 440 with at least two different coatings, including a first coating material 445, and a second coating material 450. In one embodiment, the solid particles 400 may include one or more additives (e.g., conductive, or non-conductive) to adhere to a substrate or a deposited material 480. In one implementation, the composite material formulation may include solid particles 400 having diameters configured to be significantly larger than the layer or coating of the composite material layer. As described herein, some example configurations of solid particles 400 include a range of particle sizes, materials, distributions, and morphologies (inherent or processed through varying processing parameters) that can be tailored to obtain a desired surface profile for a composite material layer. Moreover, a combination of different solid particles 400 with similar or different configurations may be implemented to modulate the surface profile. Some examples of processing parameters for modifying particle size distributions include shear rate, shear time, and degree to which solid particle agglomeration and aggregates are broken down (e.g., sedimentation, separation, and mixing efficiency) of a selected solid particle(s).

In a further aspect of the disclosure, in many implementations, the composite material layer may include one or more composite material components. For example, the composite material formulation may include solid particles, roughening agents, and one or more binders configured for a distinct temperature range and compaction pressures. Further, the composite material layer may include different composite material formulations and different types of conditioning. As an example, a composite layer (of one component material) may be heated then pressed while a composite film (of different component materials) may be simultaneously heated and pressed. The composite material layer may be configured to facilitate desirable interactions between a material deposited thereon, as well as desirable interactions between the deposited material and a substrate configured to receive the deposited material and composite material layer.

Referring to FIG. 4B, in one implementation, the composite layer 420 may include a plurality of contact areas 470 having non-uniform micro-surfaces. In one embodiment, non-uniform micro-surfaces regions with solid particles 400 may be configured to have a roughening thickness, Rt, substantially larger than a thickness of the underlying composite material layer, Ct. In one implementation, the roughening thickness, Rt, may be defined as the height of the roughening agent, and an effective thickness, T, may be defined as the thickness of the roughening agent and composite material layer: T=Ct+Rt. In some embodiments, the roughening thickness, Rt, may be defined as the thickness or diameter of the solid particle 400 based on the shape of the solid particle 400. Further, a component protrusion height, P, may be defined as the difference between the thickness of the composite layer 420 and the diameter (or thickness) of the solid particle 400, where P=T−Ct. In various implementations, the effective thickness of the composite layer 420, T, may be defined in a range from 1 μm to 20 μm. In various implementations, the particle diameter (or thickness) of the solid particle 400 (roughening agent), Rt, may be defined in a range from 1 μm to 10 μm. In various implementations, the composite layer 420 thickness, Ct, may be defined in a range from 1μ to 10 μm. In various implementations, the component protrusion height, P, may be defined in a range from 0.1 μm to 5 μm.

The non-uniform micro-surfaces regions may facilitate improved adhesion of deposited material 480 (through, for example, surface friction), improved density (through increased material adhesion and compaction), improved substrate adhesion (through a selection of binder materials), and other improvements as described herein. The improvements facilitated by composite material formulation of the present disclosure can result in higher line speeds and enable scaling of processing and production of a finished product (e.g., battery electrode, or electrical component) often needed to meet practical manufacturing requirements. In some embodiments, the contact area 470 of non-uniform micro-surface regions may cover the composite layer 420, in part, having regions of higher concentrated surface roughness and regions of less (or zero) concentrated surface roughness. Whereas, in certain embodiments, the contact area 470 of non-uniform micro-surface regions may cover the composite layer 420, in whole, having uniformly distributed surface roughness throughout the composite layer 420. As is readily contemplated, a combination of highly concentrated and uniformly concentrated non-uniform micro-surface regions may be preferred based on the material 480 deposited. For example, the edges or quadrants of a substrate (e.g., current collector) may be configured to have highly concentrated regions of non-uniform micro-surface regions to facilitate a preferred arrangement of deposited materials.

Composite Materials with Carbon-Coated Microspheres

Referring to FIGS. 5A-5B, an illustration of one embodiment of composite material components configured to facilitate desirable interactions between a composite material layer formed, a material (e.g., dry powder) deposited on the composite material layer, and powder uniformization devices configured to process the deposited material and composite material layer, in accordance with aspects of the present disclosure. In one embodiment, a composite material component may include modified solid particles 500. In one implementation, the modified solid particle 500 may include a non-conductive particle (e.g., polymer) having a coating layer of conductive material. In one embodiment, the modified solid particles 500 may include, for example, and not limited to, a polymer 510 coated with a conductive layer 515 (e.g., carbon). In some embodiments, the modified solid particles 500 may further include a conductive layer 515 coating and one or more conductive additives 535, 540, 545, 550 added to the polymer 510. As described herein, the composite material formulation may include solid particles 500 having diameters configured to be significantly larger than the layer or coating of the composite material layer. Some example configurations of solid particles 500 include a range of particle sizes, materials, distributions, and morphologies (inherent or processed through varying processing parameters) that can be tailored to obtain a desired surface profile for a composite material layer. Moreover, a combination of different solid particles 500 with similar or different configurations may be implemented to modulate the surface profile.

Referring to FIG. 5B, in one implementation, the composite layer 520 may include a plurality of contact areas 570 having conductive non-uniform micro-surfaces. In one embodiment, the conductive non-uniform micro-surfaces regions with solid particles 500 may be configured to have a roughening thickness, Mt, substantially larger than a thickness of the composite layer, Ct. In one implementation, the roughening thickness, Mt, may be defined as the height of the roughening agent, and an effective thickness, T, may be defined as the thickness of the roughening agent and composite material layer: T=Mt+Rt. In some embodiments, the roughening thickness, Mt, may be defined as the thickness or diameter of the solid particle 500 based on the shape of the solid particle 500. Further, a component protrusion height, P, may be defined as the difference between the thickness of the composite layer 420 and the diameter (or thickness) of the solid particle 500, where P=T−Mt. In various implementations, the effective thickness of the composite layer 520, T, may be defined in a range from 1 μm to 20 μm. In various implementations, the particle diameter (or thickness) of the solid particle 500 (roughening agent), Rt, may be defined in a range from 1 μm to 20 μm. In various implementations, the composite layer 520 thickness, Ct, may be defined in a range from 1 μm to 10 μm. In various implementations, the component protrusion height, P, may be defined in a range from 0.1 μm to 5 μm. In one implementation, the conductive non-uniform micro-surfaces regions with solid particles 500 may be configured as the non-uniform micro-surfaces regions as described herein.

### Method of Forming and Processing Composite Materials and Composite Material Surfaces

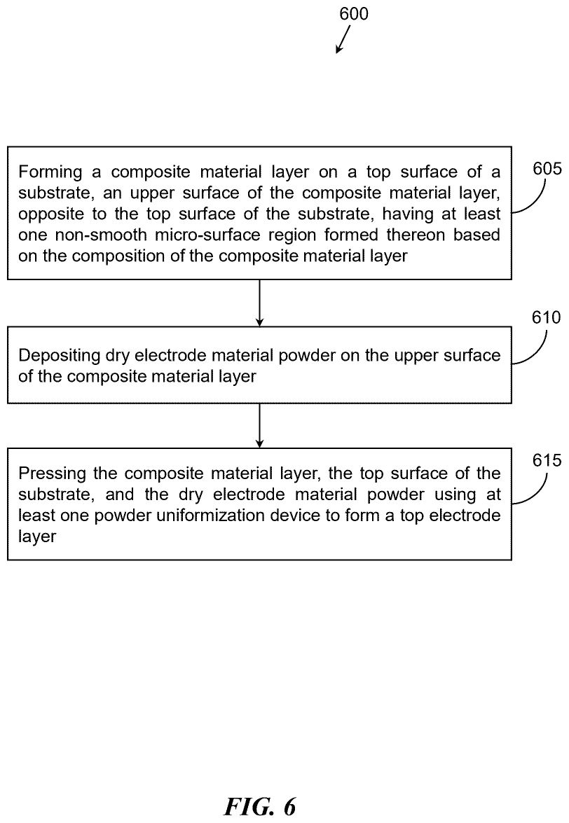

FIG. 6 illustrates an example flowchart showing a method of depositing and processing a composite material configured to facilitate desirable interactions between the composite material layer formed, a material (e.g., dry powder) deposited on the composite material layer and powder uniformization devices configured to process the deposited material and the composite material layer, in accordance with one or more embodiments of the present disclosure. These exemplary methods are provided by way of example, as there are a variety of ways to carry out these methods. Each block shown in FIG. 6 represents one or more processes, methods, or subroutines, carried out in the exemplary method. FIGS. 1, 2A-2G, 4A-4B, and 5A-5B show example embodiments of carrying out the method of FIG. 6 for facilitating desirable interactions between a composite material layer, a material (e.g., dry powder) deposited on the composite material layer and powder uniformization devices configured to process the deposited material and the composite material layer. Each block shown in FIG. 6 represents one or more processes, methods, or subroutines, carried out in the exemplary method. The exemplary method may begin at block 605. Method 600 may be used independently or in combination with other methods or process for facilitating desirable interactions between the composite material layer, a material (e.g., dry powder) deposited on the composite material layer and powder uniformization devices configured to process the deposited material and the composite material layer. For explanatory purposes, the example process 600 is described herein with reference to the printing apparatus and composite material processing of FIGS. 1, 2A-2G, 4A-4B, and 5A-5B. Further for explanatory purposes, the blocks of the example process 600 are described herein as occurring in serial, or linearly. However, multiple blocks of the example process 600 may occur in parallel. In addition, the blocks of the example process 600 may be performed in a different order than the order shown and/or one or more of the blocks of the example process 600 may not be performed. Further, any or all blocks of example process 600 may further be combined and done in parallel, in order, or out of order.

In FIG. 6, the exemplary method 600 of facilitating desirable interactions between the composite material layer, a material (e.g., dry powder) deposited on the composite material layer and powder uniformization devices configured to process the deposited material and the composite material layer. Method 600 begins at block 605. In block 605, the method includes forming a composite material layer on a top surface of a substrate, an upper surface of the composite material layer, opposite to the top surface of the substrate, having at least one non-smooth micro-surface region formed thereon based on the composition of the composite material layer. In some implementations, the composite material layer may be the substrate. The composite material layer may be configured to receive a material (e.g., dry powder) deposited thereon. In some implementations, the composite material layer may include a conductive material having different particle sizes and morphologies for forming the at least one non-smooth micro-surface region. In some embodiments, the conductive material layer may include graphite or carbon black particles. In some embodiments, the composition of the composite material layer may be configured to include conductive carbons as the conductive material. Further, the type and the dispersion of conductive carbons may be configured to form the at least one non-smooth micro-surface region. In certain embodiments, the conductive carbons may be selected from a group consisting of graphite, carbon black, and carbon nanotubes. Further, the particle sizes and/or particle size distributions of the conductive carbons may be configured to have multiple sizes to modulate the surface profile of the upper surface of the composite material layer to form the at least one non-smooth micro-surface region. For example, process parameters (e.g., a shear rate, shear time, and degree to which conductive carbon additive agglomerates and aggregates are broken down) can be varied to adjust or modulate the size, dimensions, and frequency of non-smooth micro-surface region(s) across the surface of the composite material layer. In block 610, the method includes depositing dry electrode material powder on the upper surface of the composite material layer.

In block 615, the method includes pressing the composite material layer, the top surface of the substrate, and the dry electrode material powder using at least one powder uniformization device to form a top electrode layer. In many embodiments, the at least one non-smooth micro-surface region is not removed in forming the top electrode layer. In some embodiments, the at least one non-smooth micro-surface region facilitates adhesion of dry electrode material powder deposited thereon and promotes spreading of dry electrode material powder. In some implementations, one or more dedicated, particulate roughening agents may be added to the composite material layer to form the at least one non-smooth micro-surface region. In certain embodiments, a roughening agent may provide a significant portion of the contact area between the composite material layer and the pressed top electrode layer. As an example, a roughening agent may be selected from thermoplastic polymers, thermosetting polymers (e.g., crosslinked PMMA microspheres), ceramics, metal oxides, glass, metal powders, or any combinations thereof. In some embodiments, a roughening agent may be non-conductive materials. In certain implementations, a roughening agents may be configured to include spherical conductive materials including silver-coated glass spheres and silver-coated glass bubbles.

In some implementations, the composition of the composite material layer may include carbon coated microspheres. The carbon coated microspheres may be configured to accumulate on the upper surface of the composite material layer to create the at least one non-smooth micro-surface region. In certain implementations, the diameter of the carbon coated microspheres can be greater than a coating thickness of the composite material layer. Moreover, the composite material layer may include carbon coated microspheres deposited onto the top surface of the substrate prior to depositing dry electrode material powder on the composite layer. The carbon coated microspheres may facilitate controlled surface morphology of the upper surface of the composite material layer without compromising the conductivity of the dry electrode material powder and the composite material layer to the substrate. In many embodiments, each carbon coated microsphere can include a polymer microsphere coated with a thin coating of conductive carbon to obtain the carbon coated microsphere. Moreover, the material deposited can be other than dry powder or loose dry powder, the material deposited may form an electrical contact. Additionally, the substrate and material deposited may form other components such as a solid-state battery separator, as an example. In certain embodiments, the composite material itself may be transferred from one substrate (e.g., metal substrate) to another (e.g., glass or polymer substrate).

In many embodiments, processing of the composite material layers as described herein can include multiple calendering stages for spreading and compaction of materials (e.g., dry powder) deposited thereon. In one embodiment, the material deposited (e.g., dry powder) and calendered may form an electrode layer. Further, the substrate may include a metal current collector.

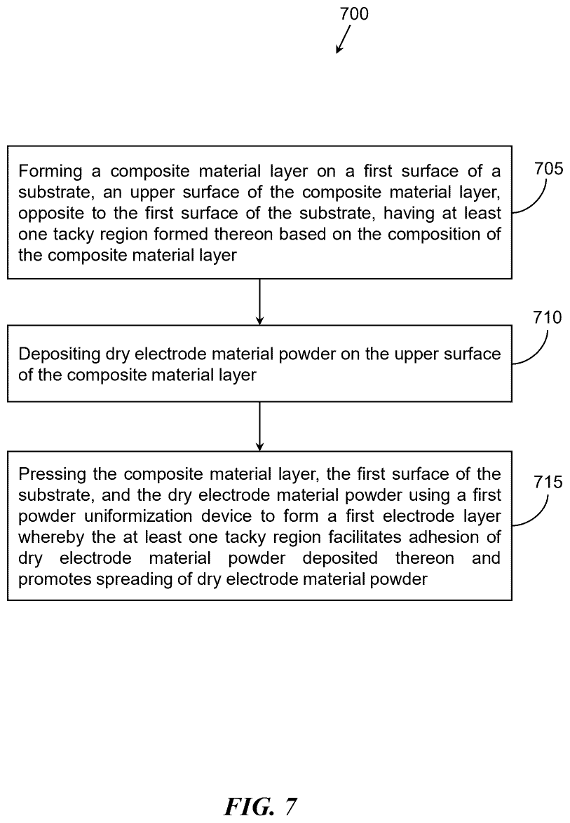

FIG. 7 illustrates an example flowchart showing a method of depositing and processing a composite material configured to facilitate desirable interactions between the composite material layer formed, a material (e.g., dry powder) deposited on the composite material layer and powder uniformization devices configured to process the deposited material and the composite material layer, in accordance with one or more embodiments of the present disclosure. These exemplary methods are provided by way of example, as there are a variety of ways to carry out these methods. Each block shown in FIG. 7 represents one or more processes, methods, or subroutines, carried out in the exemplary method. FIGS. 1, 2A-2G, 4A-4B, and 5A-5B show example embodiments of carrying out the method of FIG. 7 for facilitating desirable interactions between a composite material layer, a material (e.g., dry powder) deposited on the composite material layer and powder uniformization devices configured to process the deposited material and the composite material layer. Each block shown in FIG. 7 represents one or more processes, methods, or subroutines, carried out in the exemplary method. Method 700 may be used independently or in combination with other methods or process for facilitating desirable interactions between the composite material layer, a material (e.g., dry powder) deposited on the composite material layer and powder uniformization devices configured to process the deposited material and the composite material layer. For explanatory purposes, the example process 700 is described herein with reference to the printing apparatus and composite material processing of FIGS. 1, 2A-2G, 4A-4B, and 5A-5B. Further for explanatory purposes, the blocks of the example process 700 are described herein as occurring in serial, or linearly. However, multiple blocks of the example process 700 may occur in parallel. In addition, the blocks of the example process 700 may be performed in a different order than the order shown and/or one or more of the blocks of the example process 700 may not be performed. Further, any or all blocks of example process 700 may further be combined and done in parallel, in order, or out of order.

In FIG. 7, the exemplary method 700 of facilitating desirable interactions between the composite material layer, a material (e.g., dry powder) deposited on the composite material layer and powder uniformization devices configured to process the deposited material and the composite material layer. Method 700 begins at block 705. In block 705, the method includes forming a composite material layer on a first surface of a substrate, an upper surface of the composite material layer, opposite to the first surface of the substrate, having at least one tacky region formed thereon based on the composition of the composite material layer. In some implementations, the composite material layer may be the substrate. In various implementations and embodiments described herein, the dry electrode material powder may be processed to form an electrode, an anode, a cathode, or other electrical contact or component. The composite material layer may be configured to receive a material (e.g., dry powder) deposited thereon. In block 710, the method includes depositing dry electrode material powder on the upper surface of the composite material layer. In block 715, the method includes pressing the composite material layer, the first surface of the substrate, and the dry electrode material powder using a first powder uniformization device to form a first electrode layer. In many embodiments, the at least one tacky region facilitates adhesion of dry electrode material powder deposited thereon and promotes spreading of dry electrode material powder. In many embodiments, the tacky region is not removed in forming the first electrode layer.

In many embodiments, processing of the composite material layers as described herein can include multiple calendering stages for spreading and compaction of materials (e.g., dry powder) deposited thereon. In one embodiment, the material deposited (e.g., dry powder) and calendered may form an electrode layer. Further, the substrate may include a metal current collector.

Composite Material Layer with 3D Porous Deformable Structure

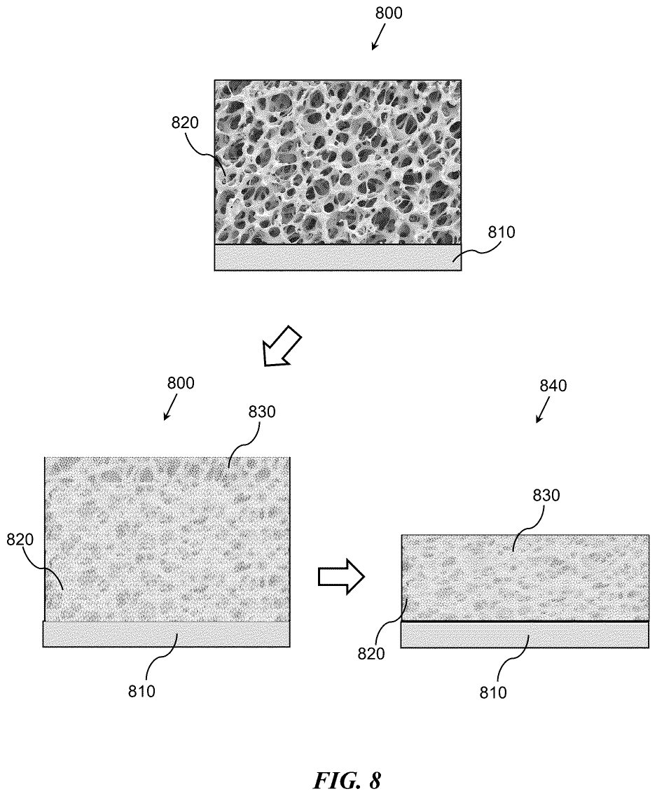

Referring to FIG. 8, in one implementation, a composite material layer having a 3D porous deformable structure is illustrated, the composite material layer configured to include composite material components that facilitate desirable interactions between a composite material layer formed, a material (e.g., dry powder) deposited on the composite material layer, and powder uniformization devices configured to process the deposited material and composite material layer as described herein. The 3D porous deformable structure 800 includes a substrate 810 with a porous deformable interlocking composite material 820 formed thereon for receiving a deposited material 830 (e.g., dry electrode material powder). Moreover, the 3D porous deformable structure 800 can facilitate adhesion of dry powder whereby the particles, for example, dry electrode material powder particles may be lodged in or passed through the porous deformable interlocking composite material 820. Upon a compaction process, the porous deformable interlocking composite material 820 may be densified together with the adhered material 830 (e.g., dry electrode material powder) to form an integrated structure 840 (e.g., an electrode layer 830 on a current collector 810). In one implementation, the porous deformable interlocking composite material 820 may have a porosity in a range from 40% to 90%. Moreover, the porous deformable interlocking composite material 820 may have a packing density of between 0.10-1.2 μm/cm³, and preferably in the range of between 0.40-0.80 μm/cm³. In one embodiment, the porous deformable interlocking composite material 820 may include interlocking conductive carbons (or other interlocking composite material) within a pore forming agent (e.g., solvent, or dissolvable material). The pore forming agent(s) may be configured as needed to control the porous structure of the composite material layer. Upon heating/pre-heating the pore forming agent may be selectively removed from the porous deformable interlocking composite material 820 to form a 3D porous deformable structure. As an example, the porous deformable interlocking composite material 820 may have a thickness of 10 μm with 60% porosity, and upon compaction (e.g., 50% compaction rate), the compacted the porous deformable interlocking composite material 820 may have a thickness of 5 μm with 30% porosity.

A comparative study was conducted to assess performance improvement of a composite material layer of the present disclosure against existing composite material layer. As shown in Table 1 below, an existing composite material layer (A0-B0) and a composite material layer and electrode layer of this present disclosure (A1-A2 and B1-B2) on a metal current collector were used for forming an electrode layer thereon by depositing a dry electrode material powder followed by conditioning and compaction.

TABLE 1

| | | | | Line Speed |
|---|---|---|---|---|
| | | Top/Bottom | Average Peel | (Powder Spreading |
| | | Calender | Strength | Speed) |
| Batch | Substrate | Temperature (°C) | (N/cm) | (m/min) |
| 1 | A0 | 195\| 90 | 0.97 | <3 |
| 2 | B0 | 195\| 90 | 0.77 | <3 |
| 4 | A1 | 195\|110 | 1.93 | >7.5 |
| 3 | B1 | 195\|130 | 1.93 | >7.5 |
| 5 | A2 | 195\|130 | 1.74 | >7.5 |
| 6 | B2 | 195\|110 | 4.24 | >7.5 |

As illustrated in Table 1, the electrode samples (A1-A2 and B1-B2) made with the composite material layer of the present disclosure show substantial improvement in peel strength and line speed (among other qualities and properties) compared to the electrode samples made with the existing composite material layer (A0-B0). As an example, line speed in excess of 7 meters/minute was achievable by using the composite material layer of the present disclosure while the line speed was limited to below 3 meters/minute with the existing composite layer.

In the following, further features, characteristics, and advantages of the instant application will be described by means of items:

Composite Material Layers with Temperature and Pressure Considerations

Item 1. A method for manufacturing an electrode for use in a battery using a dry electrode material powder comprising: forming a composite layer on a top surface of a substrate; depositing the dry electrode material powder on the composite layer; creating a temperature gradient between the dry electrode material powder, the composite layer, and the top surface of the substrate; and pressing, during the temperature gradient, the composite layer, the top surface of the substrate, and the dry powder using at least one powder uniformization device to form a top electrode layer; the composite layer capable of being activated to facilitate adhesion of the dry electrode material powder to the top surface of the substrate.

Item 2. The method of claim 1, further comprising drying the composite layer prior to depositing the dry electrode material powder on the composite layer.

Item 3. The method of claim 1, wherein the composite layer includes at least a conductive material and a polymer binder.

Item 4. The method of claim 1, further comprising preheating the composite layer to a temperature below the activation temperature of the polymer binder and applying heat during pressing of the composite layer by the at least one powder uniformization device to activate the polymer binder of the composite layer.

Item 5. The method of claim 1, further comprising heating the top electrode layer to a temperature of between 180 °C-200 °C during application of a low pressure by the at least one powder uniformization device.

Item 6. The method of claim 1, wherein the composite layer comprises of a polymer binder with a low activation temperature to ensure adhesion to dry powder at low temperatures.

Item 7. The method of claim 1, further comprising forming a composite film on a bottom surface of the substrate, the bottom surface being opposite to the top surface, the composite film capable of being activated to facilitate adhesion of the dry electrode material powder to the bottom surface of the substrate, and the created temperature gradient including the dry powder, the composite film, the bottom surface of the substrate, and the substrate.

Item 8. The method of claim 7, further comprising drying the composite film.

Item 9. The method of claim 7, wherein the composite film includes at least a conductive material and a polymer binder.

Item 10. The method of claim 8, wherein the composite film polymer binder has a different activation temperature from that of the polymer binder of the composite layer.

Item 11. The method of claim 7, further comprising preheating the composite film to a temperature below the activation temperature of the polymer binder and applying heat during pressing of the composite film by a second powder uniformization device of the at least one powder uniformization device.

Item 12. The method of claim 7, further comprising heating the composite film to a temperature of between 70 °C-130 °C, wherein the composite film is not activated; and applying a low pressure by a second powder uniformization device of the at least one powder uniformization device, wherein the substrate temperature is approximately 150 °C.

Item 13. The method of claim 12, further comprising adding an anti-blocking agent to the composite film to prevent adhesion of the composite film to the second powder uniformization device.

Item 14. The method of claim 12, wherein the composite film comprises of a polymer binder with a high activation temperature to prevent adhesion of the composite film to the second powder uniformization device.

Item 15. The method of claim 7, wherein the composite layer and the composite film have different properties to improve electrode layer interactions during power deposition and processing, wherein at least one of the following properties are different: roughness, thickness, binder thermomechanical properties, binder chemistry and loading, conductive carbon type and loading, and anti-blocking agent chemistry and loading.

Item 16. The method of claim 7, further comprising: depositing the dry electrode material powder on the composite film; heating the composite film and composite layer; wherein the at least one powder uniformization device comprises a third powder uniformization device; and pressing the composite film, the bottom surface of the substrate, and the dry powder using a third powder uniformization device to form a bottom electrode layer.

Item 17. The method of claim 16, wherein the temperature gradient is configured to activate only the composite film.

Item 18. The method of claim 16, further comprising heating the bottom electrode layer to a temperature of between 180 °C-200 °C during application of a high pressure by the third powder uniformization device to activate the polymer binder of the composite film.

Item 19. The method of claim 16, further comprising adding an anti-blocking agent to the composite film, wherein application of high pressure by the third powder uniformization device melts the anti-blocking agent to facilitate adhesion of the dry electrode material powder to the bottom surface of the substrate.

Item 20. The method of claim 16, further comprising heating the top electrode layer to a temperature of between 180 °C-200 °C during application of a high pressure by a fourth powder uniformization device of the at least one powder uniformization device.

Item 21. The method of claim 16, wherein heating the composite film and composite layer to creates a zero-temperature gradient between the top surface of the substrate, the composite layer, the bottom surface of the substrate, and the composite film.

Composite Material Layers with Powder Distribution and Surface Considerations

Item 22. A method for manufacturing an electrode for use in a battery using a dry electrode material powder, comprising: forming a composite material layer on a top surface of a substrate, an upper surface of the composite material layer, opposite to the top surface of the substrate, having at least one non-smooth micro-surface region formed thereon based on the composition of the composite material layer; depositing the dry electrode material powder on the upper surface of the composite material layer; and pressing the composite material layer, the top surface of the substrate, and the dry electrode material powder using at least one powder uniformization device to form a top electrode layer; wherein the at least one non-smooth micro-surface region facilitates adhesion of the dry electrode material powder deposited thereon and promotes spreading of the dry electrode material powder.

Item 23. The method of claim 1, further comprising configuring the composite material layer to have a three-dimensional structure with a surface area spanning across the substrate for contacting the dry electrode material powder, wherein the three-dimensional structure facilitates adhesion of dry electrode material powder deposited thereon and promotes spreading of the dry electrode material powder.

Item 24. The method of claim 2, further comprising configuring the three-dimensional structure to be porous and have a porosity in a range from 40% to 90%.

Item 25. The method of claim 1, wherein the composite material layer is selected from the group consisting of conductive carbons including graphite, carbon black, and carbon nanotubes.

Item 26. The method of claim 4, wherein the composite material layer comprises graphite and/or carbon black particles as the conductive material, and wherein the graphite and/or the carbon black particles is configured to have different particle sizes and morphologies to form the at least one non-smooth micro-surface region.

Item 27. The method of claim 4, further comprising configuring the composition of the composite material layer to include conductive carbons as the conductive material, wherein the type and the dispersion of conductive carbons are configured to form the at least one non-smooth micro-surface region.

Item 28. The method of claim 6, further comprising configuring the particles sizes of the conductive carbons to have multiple sizes to modulate the surface profile of the upper surface of the composite material layer to form the at least one non-smooth micro-surface region.

Item 29. The method of claim 7, further comprising changing the processing parameters for adding conductive carbon additives to the conductive material layer to change the particle size distributions of the conductive carbons, wherein the at least one non-smooth micro-surface region is configured based on the particle size distributions of the conductive carbon additives.

Item 30. The method of claim 8, wherein the processing parameters include a shear rate, shear time, and degree to which conductive carbon agglomerates and aggregates are broken down.

Item 31. The method of claim 4, further comprising adding one or more dedicated, particulate roughening agents to the composite material layer to form the at least one non-smooth micro-surface region.

Item 32. The method of claim 10, wherein the one or more roughening agents further provide a significant portion of the contact area between the composite material layer and the pressed top electrode layer.

Item 33. The method of claim 10, wherein the one or more roughening agents is selected from thermoplastic polymers, thermosetting polymers, ceramics, metal oxides, glass, metal powders, or any combinations thereof.

Item 34. The method of claim 10, wherein the roughening agents are non-conductive materials.

Item 35. The method of claim 10, wherein the roughening agents are configured to include conductive materials including silver-coated glass spheres and silver-coated glass bubbles.

Item 36. The method of claim 10, wherein the roughening agent thermosetting polymeric agents including crosslinked PMMA microspheres.

Item 37. The method of claim 4, further comprising configuring the composition of the composite material layer to include carbon coated polymer microspheres, wherein the carbon coated polymer microspheres accumulate on the upper surface of the composite material layer to create the at least one non-smooth micro-surface region.

Item 38. The method of claim 16, wherein the diameter of the carbon coated polymer microspheres is greater than a coating thickness of the composite material layer.

Item 39. The method of claim 16, wherein the carbon coated polymer microspheres facilitate controlled surface morphology of the upper surface of the composite material layer without compromising the electric conductivity of the dry powder and the composite material layer to the substrate.

Item 40. The method of claim 16, wherein each carbon coated polymer microsphere comprises a polymer microsphere and the polymer microsphere is coated with a thin coating of conductive carbon to obtain the carbon coated polymer microspheres.

Item 41. The method of claim 19, wherein the carbon coating of the carbon coated polymer microsphere is amorphous carbon black and the polymer microsphere is an insulative polymer microsphere.

Item 42. The method of claim 19, further comprising configuring the carbon coated polymer microspheres to have a range of particle sizes and low densities.

Item 43. The method of claim 19, wherein the polymer microsphere comprises a thermosetting polymeric agent including crosslinked Poly(Methyl Methacrylate) (PMMA) microsphere.

Item 44. The method of claim 1, wherein the composite layer further comprises a tacky material to increase adhesion of the deposited dry electrode material powder thereon.

Item 45. The method of claim 23, wherein the tacky material includes a B-stage epoxy resin, and wherein the tackiness of the composite layer is between 0.05 to 5.00 N/m.

Item 46. The method of claim 1, wherein the composite layer comprises a conductive material and a polymer binder configured to be activated to facilitate adhesion of the dry electrode material powder deposited thereon.

Item 47. The method of claim 25, further comprising creating a temperature gradient between the dry electrode material powder, the composite layer, and the top surface of the substrate, and pressing, during the temperature gradient, the composite layer, the top surface of the substrate, and the dry electrode material powder using at least one powder uniformization device to form a bottom electrode layer

### DEFINITIONS

A “feeder”, “hopper”, or “funnel” as used herein includes, but is not limited to, any container or structure having one or more openings for holding and dispensing material.

A “material deposited,” dry powder”, “dry powder material”, “dry powder electrode”, “dry powder anode”, “dry powder cathode”, “loose powder”, “loose dry powder”, “particle”, “particulate”, “powder material”, or “powder layer” as used herein includes, but is not limited to, any particle or particulate of a dry powder material, dry powder materials, or dry powder compositions that may be altered (e.g., mixed with one or more particles, binders, solvents, conductive additives, or active anode or cathode materials) and/or conditioned through one or more conditioning means to improve flowability, cohesion, and handleability, and are used herein interchangeably. The material deposited may include one or more layers or structures formed, and is not to be limited to electrodes, anodes, or cathodes, and can include any electrical component, surface or component coating.

A “agitation”, “actuation”, or “vibration” as used herein includes, but is not limited to, any application of mechanical energy to a surface that can emit longitudinal, radial, or transverse waves to displace powder or material resting on the surface or impart energy to the powder or material to effectuate motion of the powder or material.

A “substrate”, “continuous substrate”, “flexible substrate”, “current collector”, or “conductive substrate” as used herein, includes, but is not limited to, any individual, segmented, or continuous substrate, flexible or rigid, configured for supporting material deposited or coated thereon. The substrate may be conductive and may be processed and conditioned through variety of processing and conditioning devices associated with a printing apparatus as described herein.

A “composite material layer,” “composite film,” “composite material,” “composite surface,” “composite layer,” “adhesion layer”, “primer coating”, “primer layer”, or “primer,” as used herein, includes, but is not limited to, any composition of two or more materials, or different properties or states of the same material (e.g., amorphous or polycrystalline), that when deposited facilitates desirable interactions with: (i) a conditioning device/processing device used to process the composition of two or more materials, (ii) a conditioning device/processing device used to process the composition of two or more materials and a substrate for receiving the composition thereof, (iii) one or more materials deposited thereon (e.g., dry powder), (iv) one or more materials deposited thereon (e.g., dry powder) and conditioned/processed using a conditioning device, (v) or any combinations thereof.

A “conditioning device,” “conditioning unit,” “processing,” “conditioning,” or “conditioning system,” as used herein, includes, but is not limited to, any apparatus, device, or method that can facilitate smoothing, pressing, heating, compaction, improving adhesion, cohesion, uniformity, compaction, electrochemical properties, or any other characteristic or property of the composite material, composite film, composite layer, substrate, and material deposited (e.g., dry powder and particles, additives, or components of the dry powder composition), and are used herein interchangeably.

### DEFINITIONS AND OTHER EMBODIMENTS

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (Saas) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional, and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

The term “within a proximity”, “a vicinity”, “within a vicinity”, “within a predetermined distance”, “predetermined width”, “predetermined height”, “predetermined length” and the like may be defined between about 0.01 centimeter and about 0.5 meters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The term “a predefined” or “a predetermined” when referring to length, width, height, or distances may be defined as between about 0.01 centimeter and about 0.5 meters.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may. The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

### DEFINITIONS AND OTHER EMBODIMENTS

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (Saas) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from those shown and described. Moreover, less than all the illustrated blocks may be used to implement an example methodology. Blocks may be combined or separated into multiple actions/components. Furthermore, additional, and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The term “adjacent”, “within a proximity”, “a vicinity”, “within a vicinity”, “within a predetermined distance”, “predetermined width”, “predetermined height”, “predetermined length” and the like may be defined between about 0.01 centimeter and about 0.5 meters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The term “a predefined” or “a predetermined” when referring to length, width, height, or distances may be defined as between about 0.01 centimeter and about 0.5 meters.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may. The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A method for manufacturing an electrode for use in a battery using a dry electrode material powder, comprising:
forming a composite material layer on a top surface of a substrate, an upper surface of the composite material layer, opposite to the top surface of the substrate, having at least one non-smooth micro-surface region formed thereon based on the composition of the composite material layer;
depositing the dry electrode material powder on the upper surface of the composite material layer; and
pressing the composite material layer, the top surface of the substrate, and the dry electrode material powder using at least one powder uniformization device to form a top electrode layer;
wherein the at least one non-smooth micro-surface region facilitates adhesion of the dry electrode material powder deposited thereon and promotes spreading of the dry electrode material powder.

2. The method of claim 1, further comprising configuring the composite material layer to have a three-dimensional structure with a surface area spanning across the substrate for contacting the dry electrode material powder, wherein the three-dimensional structure facilitates adhesion of dry electrode material powder deposited thereon and promotes spreading of the dry electrode material powder.

3. The method of claim 2, further comprising configuring the three-dimensional structure to be porous and have a porosity in a range from 40% to 90%.

4. The method of claim 1, wherein the composite material layer is selected from the group consisting of conductive carbons including graphite, carbon black, and carbon nanotubes.

5. The method of claim 4, wherein the composite material layer comprises graphite and/or carbon black particles as the conductive material, and wherein the graphite and/or the carbon black particles is configured to have different particle sizes and morphologies to form the at least one non-smooth micro-surface region.

6. The method of claim 4, further comprising configuring the composition of the composite material layer to include conductive carbons as the conductive material, wherein the type and the dispersion of conductive carbons are configured to form the at least one non-smooth micro-surface region.

7. The method of claim 6, further comprising configuring the particles sizes of the conductive carbons to have multiple sizes to modulate the surface profile of the upper surface of the composite material layer to form the at least one non-smooth micro-surface region.

8. The method of claim 4, further comprising adding one or more dedicated, particulate roughening agents to the composite material layer to form the at least one non-smooth micro-surface region.

9. The method of claim 8, wherein the one or more roughening agents further provide a significant portion of the contact area between the composite material layer and the pressed top electrode layer.

10. The method of claim 8, wherein the one or more roughening agents is selected from thermoplastic polymers, thermosetting polymers, ceramics, metal oxides, glass, metal powders, or any combinations thereof.

11. The method of claim 8, wherein the roughening agents are non-conductive materials.

12. The method of claim 8, wherein the roughening agents are configured to include conductive materials including silver-coated glass spheres and silver-coated glass bubbles.

13. The method of claim 8, wherein the roughening agent thermosetting polymeric agents including crosslinked PMMA microspheres.

14. The method of claim 4, further comprising configuring the composition of the composite material layer to include carbon coated polymer microspheres, wherein the carbon coated polymer microspheres accumulate on the upper surface of the composite material layer to create the at least one non-smooth micro-surface region.

15. The method of claim 14, wherein the diameter of the carbon coated polymer microspheres is greater than a coating thickness of the composite material layer.

16. The method of claim 14, wherein the further comprising configuring the carbon coated polymer microspheres to have a range of particle sizes and low densities.

17. The method of claim 1, wherein the composite layer further comprises a tacky material to increase adhesion of the deposited dry electrode material powder thereon.

18. The method of claim 17, wherein the tacky material includes a B-stage epoxy resin, and wherein the tackiness of the composite layer is between 0.05 to 5.00 N/m.

19. The method of claim 1, wherein the composite layer comprises a conductive material and a polymer binder configured to be activated to facilitate adhesion of the dry electrode material powder deposited thereon.

20. The method of claim 19, further comprising creating a temperature gradient between the dry electrode material powder, the composite layer, and the top surface of the substrate, and pressing, during the temperature gradient, the composite layer, the top surface of the substrate, and the dry electrode material powder using at least one powder uniformization device to form a bottom electrode layer.
